(19) United States
(12) Patent Application Publication
(10) Pub. No.: US 2026/0185380 A1
(43) Pub. Date: Jul. 2, 2026

(54) DISH WASHER AND HOME APPLIANCE

(71) Applicant: LG Electronics Inc., Seoul (KR)

(72) Inventors: Jaehyun RA, Seoul (KR); Sang Woo WOO, Seoul (KR); Jaewoong KIM, Seoul (KR); Jinhong KIM, Seoul (KR); Seunghoon LEE, Seoul (KR); Hyeonjoon PARK, Seoul (KR)

(21) Appl. No.: 19/416,286

(22) Filed: Dec. 11, 2025

(30) Foreign Application Priority Data
Dec. 30, 2024 (KR) 10-2024-0199776
May 22, 2025 (KR) 10-2025-0066592

(51) Int. Cl. E05B 5/02; A47L 15/42; E05B 5/00; F21V 33/00

(52) U.S. Cl. CPC E05B 5/003; A47L 15/4257; E05B 5/006; F21V 33/0044

(57) ABSTRACT

A dish washer and a home appliance are described. A handle is configured to automatically protrude and move frontwards from a door only when necessary such as opening and closing of the door, and whether the handle is normally operating and an operating state thereof are visually transmitted to a user via a handle illuminator, thereby remarkably improving user convenience and aesthetics.

### CROSS-REFERENCE TO RELATED APPLICATION

This application claims priority to and benefit of Korean Patent Application No. 10-2024-0199776, filed on Dec. 30, 2024, and Korean Patent Application No. 10-2025-0066592, filed on May 22, 2025, which are hereby incorporated by reference as when fully set forth herein.

### BACKGROUND

### Field

The present disclosure relates to a dish washer and a home appliance, and more specifically, to a dish washer and a home appliance in which a handle is configured to automatically protrude and move frontwards from a door only when necessary such as opening and closing of the door, and whether the handle is normally operating and an operating state thereof are visually transmitted to a user via a handle illuminator, thereby remarkably improving user convenience and aesthetics.

### Description of Related Art

A dish washer is an apparatus that washes dishes and cooking utensils as washing targets stored therein by spraying washing water thereto. In this regard, the washing water may contain washing detergent.

A dish washer generally includes a washing tub having a washing space defined therein, a dish rack that accommodates therein a washing target inside the washing tub, a spraying arm that sprays the washing water into the dish rack, and a sump that stores therein water and supplies the washing water to the spraying arm.

Using this dish washer may allow a time and effort required to wash the dishes and other washing targets after a meal to be reduced, thereby contributing to user convenience.

Generally, the dish washer is configured to perform a washing cycle for washing a washing target, a rinsing cycle for rinsing a washing target, and a drying cycle for drying a washing target that has been washed and rinsed.

In order to store dishes inside the dish washer before the cycle proceeds, and to withdraw the washed and dried dishes after the cycle has been completed, the user should open and close the door.

In this regard, it is common that the door is provided with a handle that the user may grip as a means for facilitating the opening and closing of the door.

In this regard, European Patent No. 2096360 (Prior Document 001) discloses a dish washer configured such that a pop-up handle protruding from a front surface of the door during gripping for opening and closing the door is provided in the door.

### Prior Art Documents

### Patent Documents

(Patent document 001) European Patent No. 2096360

### SUMMARY

The handle disclosed in Prior Document 001 described above is configured to manually protrude from a non-use position at which an amount of protrusion thereof from the door is minimized toward a use position at which it may be gripped by the user while rotating.

Accordingly, the handle disclosed in Prior Document 001 requires a manipulation of the user of manually moving the same from the non-use position to the use position and a manipulation of the user of manually moving the same from the use position to the non-use position again when the opening and closing of the door is completed, and thus inconvenience of the user may be caused.

Further, the handle disclosed in Prior Document 001 does not include a means for allowing the user to check whether the handle is normally moving to the use position during the movement from the non-use position to the use position.

Accordingly, the handle disclosed in Prior Document 001 is highly likely to be damaged when the user grips the same and opens the door in a state in which the handle has not normally moved to the use position.

Further, the handle disclosed in Prior Document 001 does not include a means capable of visually guiding an accurate gripping position in a situation in which an amount of ambient light is insufficient, such as at night time.

Accordingly, the handle disclosed in Prior Document 001 is highly likely to cause the inconvenience to the user or even injury to the user because the user is not able to grip the handle at the accurate position in the situation in which the amount of ambient light is insufficient, such as at night time.

The present disclosure has been devised to solve the problems of the prior art. A first purpose of the present disclosure is to provide a dish washer and a home appliance in which a handle is configured to automatically protrude and move frontwards from a door only when necessary such as opening and closing of the door, and whether the handle is normally operating and an operating state thereof are visually transmitted to a user via a handle illuminator, thereby remarkably improving user convenience and aesthetics.

Further, a second purpose of the present disclosure is to provide a dish washer and a home appliance configured to effectively guide an accurate gripping position of a handle in a situation in which an amount of ambient light is insufficient such as at night time via a handle illuminator, thereby improving user convenience and effectively preventing damage to the handle and injury to the user.

Further, a third purpose of the present disclosure is to provide a dish washer and a home appliance configured to minimize the number of lighting elements constituting a handle illuminator and uniformly irradiate visible light to the outside of a handle with a minimum number of lighting elements, thereby minimizing power consumption and simplifying an internal structure of the handle.

Purposes of the present disclosure are not limited to the above-mentioned purposes, and other purposes and advantages of the present disclosure that are not mentioned may be understood by the following description, and will be more clearly understood by embodiments of the present disclosure. In addition, it will be readily seen that purposes and advantages of the present disclosure may be realized by means indicated in the claims and combinations thereof.

One aspect of the present disclosure provides a dish washer comprising: a tub defining therein a washing space having an open front surface; a door configured to open and close the open front surface of the tub; and a handle configured to reciprocate back and forth between an extended position where the handle protrudes frontwards from the door and a retracted position where the handle is at least partially accommodated in the door, wherein the handle includes: a handle body exposed outwardly of the door when the handle moves to the extended position; and a handle illuminator configured to generate visible light from inside of the handle and irradiate visible light outwardly of the handle.

In accordance with some embodiments of the dish washer, the handle illuminator includes: a handle substrate disposed such that a thickness direction thereof is parallel to a front-rear direction; and a plurality of lighting elements mounted on a front surface or a rear surface of the handle substrate.

In accordance with some embodiments of the dish washer, the plurality of lighting elements are linearly arranged along a single line extending in a left-right direction.

In accordance with some embodiments of the dish washer, the single line equally divides the handle substrate based on a vertical direction.

In accordance with some embodiments of the dish washer, the plurality of lighting elements are linearly arranged along a first line extending along a left-right direction and a second line positioned below the first line and extending along the left-right direction in parallel with the first line.

In accordance with some embodiments of the dish washer, a first vertical spacing between an upper edge of the handle substrate and the first line and a second vertical spacing between a lower edge of the handle substrate and the second line are equal to each other.

In accordance with some embodiments of the dish washer, left-right directional spacings between respective pairs of lighting elements disposed adjacent to each other among the plurality of lighting elements are uniform.

In accordance with some embodiments of the dish washer, left-right directional spacings between respective pairs of lighting elements disposed adjacent to each other among the plurality of lighting elements vary in a direction toward a left edge or a right edge of the handle substrate.

In accordance with some embodiments of the dish washer, a left-right directional spacing between a pair of lighting elements disposed closest to the left edge of the handle substrate and a left-right directional spacing between a pair of lighting elements disposed closest to the right edge of the handle substrate are the smallest.

In accordance with some embodiments of the dish washer, the left-right directional spacing between the pair of lighting elements disposed closest to the left edge of the handle substrate and the left-right directional spacing between the pair of lighting elements disposed closest to the right edge of the handle substrate are equal to each other.

In accordance with some embodiments of the dish washer, the handle substrate includes a plurality of through holes defined through the handle substrate in the thickness direction.

In accordance with some embodiments of the dish washer, at least one of the plurality of lighting elements is disposed between a through hole defined at a leftmost side among the plurality of through holes and a left edge of the handle substrate.

In accordance with some embodiments of the dish washer, at least one of the plurality of lighting elements is disposed between a through hole defined at a rightmost side among the plurality of through holes and a right edge of the handle substrate.

In accordance with some embodiments of the dish washer, the handle illuminator further includes a light guide plate coupled to the handle body and configured to transmit visible light generated from the lighting elements to the outside, wherein the handle substrate is accommodated in the light guide plate.

In accordance with some embodiments of the dish washer, the light guide plate includes: a main plate having an outer edge surface exposed to the outside; and an accommodating portion defining rib protruding from a rear surface of the main plate toward the handle body and defining a space where the handle substrate is accommodated, wherein an outer peripheral surface of the accommodating portion defining rib is in contact with an inner surface of the handle body.

In accordance with some embodiments of the dish washer, a protruding height of the accommodating portion defining rib from the rear surface of the main plate is greater than a thickness of the main plate.

In accordance with some embodiments of the dish washer, the handle substrate is disposed inward of the accommodating portion defining rib in a state of being spaced apart from an inner peripheral surface of the accommodating portion defining rib.

In accordance with some embodiments of the dish washer, the plurality of lighting elements are arranged on the rear surface of the handle substrate to face an inner surface of the handle body, wherein visible light generated from the lighting elements is reflected by the inner surface of the handle body and then is incident on the light guide plate.

In accordance with some embodiments of the dish washer, the inner surface of the handle body includes one of a flat portion extending parallel to the handle substrate and a curved portion forming a continuous surface with the flat portion and concavely recessed in a direction away from the handle substrate.

Another aspect of the present disclosure provides a home appliance comprising: a door configured to open and close an inner space having an open front surface; and a handle configured to horizontally move between an extended position where the handle protrudes frontwards from the door and a retracted position where the handle is at least partially accommodated in the door, wherein the handle includes a handle illuminator configured to generate visible light from inside of the handle and irradiate visible light outwardly of the handle.

The dish washer and the home appliance according to the present disclosure may include the handle configured to automatically protrude and move frontwards from the door only when necessary such as the opening and closing of the door, and whether the handle is normally operating and the operating state thereof are visually transmitted to the user via the handle illuminator, thereby remarkably improving the user convenience and the aesthetics.

Further, the dish washer and the home appliance according to the present disclosure may be configured to effectively guide the accurate gripping position of the handle in the situation in which the amount of ambient light is insufficient such as at night time via the handle illuminator, thereby improving the user convenience and effectively preventing the damage to the handle and the injury to the user.

Further, the dish washer and the home appliance according to the present disclosure may be configured to minimize the number of lighting elements constituting the handle illuminator and uniformly irradiate the visible light to the outside of the handle with the minimum number of lighting elements, thereby minimizing the power consumption and simplifying the internal structure of the handle.

Further, the dish washer and the home appliance according to the present disclosure may secure the maximum coupling area between the light guide plate in which the handle substrate is supported and accommodated and the handle body coupled to the light guide plate as the light guide plate is at least partially inserted thereinto, thereby improving overall strength of the handle, improving a coupling strength between the light guide plate and the handle body, and at the same time, ensuring a sealing performance of the handle substrate.

In addition to the above-described effects, specific effects of the present disclosure will be described together while describing specific matters for implementing the present disclosure.

### BRIEF DESCRIPTION OF DRAWINGS

FIG. 1 is a front perspective view of a dish washer according to one embodiment of the present disclosure.

FIG. 2 is a schematic cross-sectional view of the dish washer as shown in FIG. 1.

FIG. 3 is a front perspective view showing a state in which a pop-up handle of a dish washer according to an embodiment of the present disclosure has been displaced to a retracted position.

FIG. 4 is a front perspective view showing a state in which the pop-up handle as shown in FIG. 3 has been displaced to an extended position.

FIG. 5 is a side enlarged side view of FIG. 4.

FIGS. 6 and 7 are front and rear views of a pop-up handle shown in FIG. 5.

FIG. 8 is an exploded perspective view of FIG. 6, and FIG. 9 is an exploded perspective view of FIG. 7.

FIG. 10 is a partially enlarged view of FIG. 7.

FIGS. 11 and 12 are rear views of a handle substrate shown in FIGS. 8 and 9.

FIGS. 13 to 15 are partially enlarged views showing a state in which a handle substrate shown in FIGS. 8 and 9 is accommodated in a light guide plate.

FIG. 16 is a cross-sectional view of FIG. 15 taken along a vertical surface.

FIGS. 17 and 18 are cross-sectional views of a pop-up handle according to a first embodiment of the present disclosure taken along a vertical surface.

FIGS. 19 and 20 are cross-sectional views of a pop-up handle according to a second embodiment of the present disclosure taken along a vertical surface.

FIGS. 21 and 22 are cross-sectional views of a pop-up handle according to a third embodiment of the present disclosure taken along a vertical surface.

FIG. 23 is a rear perspective view of a door shown in FIG. 3, illustrating a state in which a rear panel of the door is removed.

FIG. 24 is a rear perspective view of a handle driver shown in FIG. 23.

### DETAILED DESCRIPTION

The above-mentioned purpose, features and advantages are described in detail below with reference to the attached drawings. Accordingly, a person skilled in the art in the technical field to which the present disclosure belongs will be able to easily implement the technical idea of the present disclosure. In describing the present disclosure, when it is determined that a detailed description of the known technology related to the present disclosure may unnecessarily obscure the gist of the present disclosure, the detailed description thereof is omitted. Hereinafter, preferred embodiments according to the present disclosure will be described in detail with reference to the attached drawings. In the drawings, identical reference numerals are used to indicate identical or similar components.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described later could be termed a second element, component, region, layer or section, without departing from the spirit and scope of the present disclosure.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise.

It will also be understood that when a first element or layer is referred to as being present “on” a second element or layer, the first element may be disposed directly on the second element or may be disposed indirectly on the second element with a third element or layer being disposed between the first and second elements or layers. It will also be understood that when a first element or layer is referred to as being present “under” a second element or layer, the first element may be disposed directly under the second element or may be disposed indirectly under the second element with a third element or layer being disposed between the first and second elements or layers.

It will be understood that when an element or layer is referred to as being “connected to”, or “coupled to” another element or layer, it may be directly connected to or coupled to another element or layer, or one or more intervening elements or layers therebetween may be present. In addition, it will also be understood that when an element or layer is referred to as being “between” two elements or layers, it may be the only element or layer between the two elements or layers, or one or more intervening elements or layers therebetween may also be present.

It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

Spatially relative terms, such as “beneath,” “below,” “lower,” “under,” “above,” “upper,” and the like, may be used herein for ease of explanation to describe one element or feature's relationship to another element or feature as illustrated in the figures. It will be understood that the spatially relative terms are intended to encompass different orientations of the device in use or in operation, in addition to the orientation depicted in the figures. For example, when the device in the drawings may be turned over, elements described as “below” or “beneath” or “under” other elements or features would then be oriented “above” the other elements or features. Thus, the example terms “below” and “under” may encompass both an orientation of above and below. The device may be otherwise oriented for example, rotated 90 degrees or at other orientations, and the spatially relative descriptors used herein should be interpreted accordingly.

As used herein, “A and/or B” means A, B or A and B, unless specifically stated otherwise. Expression such as “at least one of” when preceding a list of elements may modify the entirety of list of elements and may not modify the individual elements of the list. As used herein, “C to D” means C inclusive to D inclusive unless otherwise specified.

Hereinafter, the present disclosure will be described with reference to drawings showing a configuration according to an embodiment of the present disclosure.

### Overall Structure of Dish Washer

Hereinafter, an overall structure of a dish washer 1 according to an embodiment of the present disclosure will be described in detail with reference to the attached drawings.

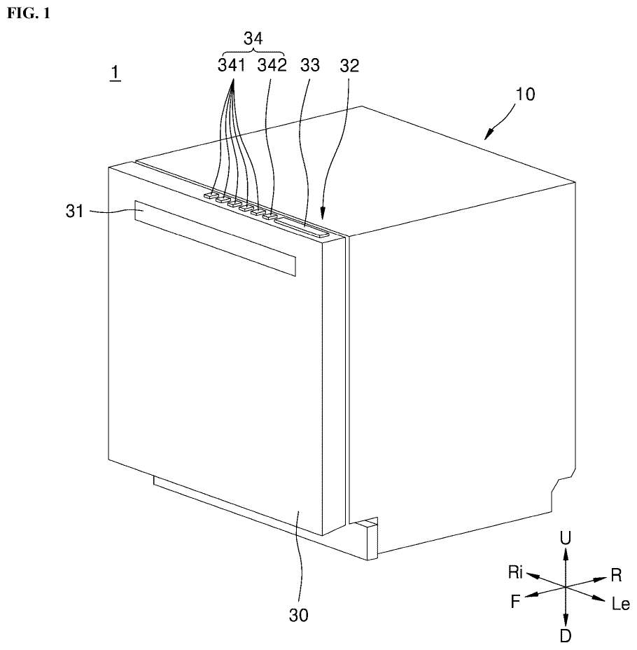

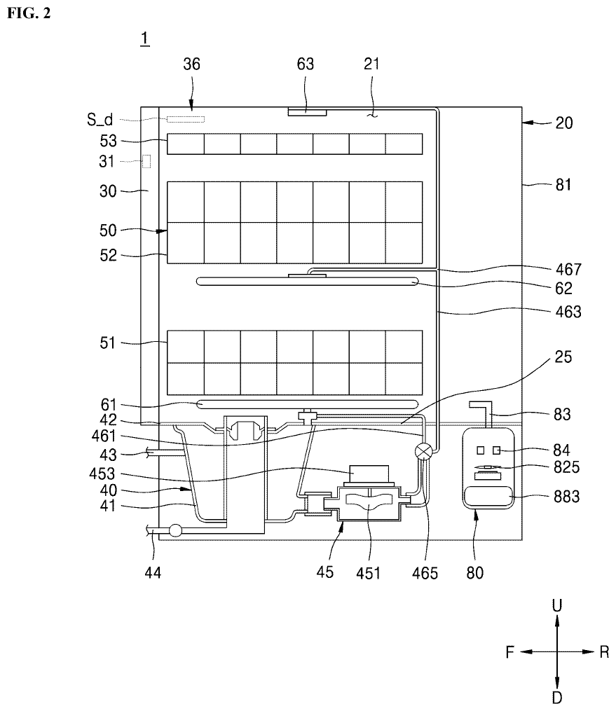

FIG. 1 is a front perspective view showing the dish washer 1 according to the present disclosure. FIG. 2 is a simplified cross-sectional view briefly showing an internal structure of the dish washer 1 according to the present disclosure.

As shown in FIG. 1 and FIG. 2, the dish washer 1 according to the present disclosure may include a casing 10 that constitutes an exterior appearance.

Further, the dish washer 1 according to the present disclosure may include a tub 20 installed inside the casing 10, defining therein a washing space 21 in which a washing target is washed, and having an open front surface.

Further, the dish washer 1 according to the present disclosure may include a door 30 that opens/closes the open front surface of the tub 20.

Further, the dish washer 1 according to the present disclosure may include a driver 40 located under the tub 20 to supply, collect, circulate, and discharge the washing water for washing the washing target.

Further, the dish washer 1 according to the present disclosure may include a dish rack 50 detachably disposed in the inner washing space 21 of the tub 20 and on which the washing target is seated.

Further, the dish washer 1 according to the present disclosure may include a water sprayer 60 installed adjacent to the dish rack 50 to spray the washing water for washing the washing target thereto.

In this regard, the washing target seated on the dish rack 50 may be, for example, dishes such as bowls, plates, spoons, and chopsticks, and other cooking utensils. Hereinafter, unless otherwise specified, the washing target will be referred to as a dish.

The tub 20 may be formed in a box shape with an entirely open front surface, and corresponds to a configuration known as a so-called washing tank.

The washing space 21 may be defined inside the tub 20. The open front surface of the tub 20 may be opened/closing by the door 30.

The tub 20 may be formed via pressing of a metal plate resistant to high temperature and moisture, for example, a stainless steel plate.

Moreover, on an inner surface of the tub 20, a plurality of brackets may be disposed for the purpose of supporting and installing functional components such as the dish rack 50 and the water sprayer 60 which will be described later thereon within the tub 20.

In one example, the driver 40 may include a sump 41 that stores therein washing water.

Further, the driver 40 may include a sump cover 42 that distinguishes the sump 41 from the tub 20.

Further, the driver 40 may include a water supply 43 that supplies washing water from an external source to the sump 41.

Further, the driver 40 may include a water discharger 44 that discharges the washing water of the sump 41 to an outside.

Further, the driver 40 may include a washing pump 45 and a supply flow path 46 for supplying the washing water of the sump 41 to the water sprayer.

The sump cover 42 may be disposed at a top of the sump 41 and may serve to distinguish the tub 20 and the sump 41 from each other.

Moreover, the sump cover 42 may have a plurality of collecting holes defined therein for collecting washing water sprayed into the washing space 21 through the water sprayer 60 into the sump 41.

That is, the washing water sprayed from the water sprayer toward the dish may fall down to a bottom of the washing space 21, and may be collected again through the sump cover 42 and into the sump 41.

The washing pump 45 may be disposed at one side of the sump 41 and may serve to pressurize the washing water and supply the pressurized washing water to the water sprayer 60.

One end of the washing pump 45 may be connected to the sump 41 and the other end thereof may be connected to the supply flow path 46. The washing pump 45 may include an impeller 451 and a motor 453. When power is supplied to the motor 453, the impeller 451 may rotate, and thus the washing water in the sump 41 may be pressurized, and then may be supplied to the water sprayer through the supply flow path 46.

Although not shown, the washing pump 45 may include a washing water heater for heating washing water supplied during a washing cycle or a heating rinsing cycle.

In one example, the supply flow path 46 may serve to selectively supply the washing water supplied from the washing pump 45 to the water sprayer 60.

For example, the supply flow path 46 may include a first supply flow path 461 connected to a lower spraying arm 61, and a second supply flow path 463 connected to an upper spraying arm 62 and a top nozzle 63.

The supply flow path 46 may be provided with a supply flow path switching valve 465 that selectively opens/closes the supply flow paths 461 and 463.

In this regard, the supply flow path switching valve 465 may be controlled so that the supply flow paths 461 and 463 are opened sequentially or simultaneously.

In one example, the water sprayer 60 may be configured to spray the washing water to the dishes stored on the dish rack 50.

More specifically, the water sprayer 60 may include the lower spraying arm 61 located at a lower portion of the tub 20 to spray the washing water to a lower rack 51.

Further, the water sprayer 60 may include the upper spraying arm 62 located between the lower rack 51 and an upper rack 52 to spray the washing water to the lower rack 51 and the upper rack 52.

Further, the water sprayer 60 may include the top nozzle 63 located at an upper portion of the tub 20 to spray the washing water to a top rack 53 or the upper rack 52.

In particular, the lower spraying arm 61 and the upper spraying arm 62 may be rotatably disposed in the washing space 21 of the tub 20 and may spray the washing water toward the dish of the dish rack 50 while rotating.

The lower spraying arm 61 may be rotatably supported above the sump cover 42 so as to spray the washing water toward the lower rack 51 while rotating and being disposed under the lower rack 51.

Moreover, the upper spraying arm 62 may be rotatably supported by a spraying arm holder 467 so as to spray the washing water on the dish while rotating and being disposed between the lower rack 51 and the upper rack 52.

In one example, although not shown, in order to increase washing efficiency, additional means for diverting the washing water sprayed from the lower spraying arm 61 into an upward direction (diverting in a U-direction) may be provided at a lower surface 25 of the tub 20.

A detailed configuration of the water sprayer 60 has been already known in the art. Thus, a description of the specific configuration of the water sprayer 60 will be omitted below.

The dish rack 50 for storing the dish therein may be disposed in the washing space 21.

The dish rack 50 may be configured to extend or retract from or into the inner space of the tub 20 through the open front surface of the tub 20.

For example, in FIG. 2, an embodiment is shown in which the dish rack includes the lower rack 51 located at the lower portion of the tub 20 to accommodate thereon relatively large dishes, the upper rack 5 located on top of the lower rack 51 to accommodate thereon medium-sized dishes, and the top rack 53 located at a top level of the tub 20 and capable of storing thereon small dishes, etc. However, However, embodiments of present disclosure are not limited thereto. However, hereinafter, an example in which the dish washer 1 includes the three dish racks 50 as shown is described.

Each of the lower rack 51, the upper rack 52, and the top rack 53 may be configured to extend to the outside through the open front surface of the tub 20.

To this end, guide rails (not shown) may be respectively disposed on both opposing inner side walls constituting an inner surface of the tub 20. By way of example, the guide rails may include an upper rail, a lower rail, and a top rail.

Wheels may be disposed on a bottom of each of the lower rack 51, the upper rack 52, and the top rack 53. The user may extend the lower rack 51, the upper rack 52, and the top rack 53 to the outside through the open front surface of the tub 20 and may place the dishes thereon, or easily withdraw the dishes that have been washed out thereof.

The guide rail (not shown) may be embodied as a simple rail-type fixed guide rail to guide the extending or the retracting of the rack 50, or a telescopic guide rail capable of guiding the extending or the retracting of the rack 50 and at the same time, increasing an extension distance thereof as the rack 50 further extends from the inner space of the tub.

In one example, the door 30 is configured for opening/closing the open front surface of the tub 20 as described above.

A hinge (not shown) around which the door 30 is closed or opened may be generally provided at a bottom of the open front surface. Thus, the door 30 may open by pivoting around the hinge as a pivot axis.

In this regard, a handle 31 for opening the door 30 and a control panel 32 for controlling an operation of the dish washer 1 may be disposed on an outer side surface of the door 30.

As shown, the control panel 32 may include a display 33 that visually displays information regarding a current operating status of the dish washer 1, etc., and a button unit 34 including a selection button through which a user's course selection manipulation is input and a power button through which a user's manipulation for turning the dish washer on and off is input.

In one example, a rear panel constituting an inner side surface of the door 30 may constitute one surface of the tub 20 when the door 30 has been closed, and may constitute a seat surface on which the lower rack 51 of the dish rack 50 is supported when the door 30 is fully opened.

To this end, when the door 30 is fully opened downwardly, the rear panel of the door 30 may constitute a horizontal plane extending in the same direction as a direction in which the guide rail guiding the displacement of the lower rack 51 extends.

In one example, unlike a conventional handle, the handle 31 of the dish washer 1 according to the present disclosure may be configured to be at least partially accommodated in an inside of the door 30 when the handle is not in use, and to automatically extend in a protruding manner in a frontward direction from the door 30 when it is necessary to open and close the door 30.

In that the handle is configured to retract so as to be at least partially accommodated in the inside of the door 30 or extend in a protruding manner in a frontward direction from the door 30 out of the inside of the door 30, the handle 31 may be referred to as various names such as a pop-up handle, a retractable handle, an extendable handle, etc.

Hereinafter, the handle 31 configured to retract into or extend from the door 30 of the dish washer 1 according to one embodiment of the present disclosure will be referred to as the pop-up handle 31.

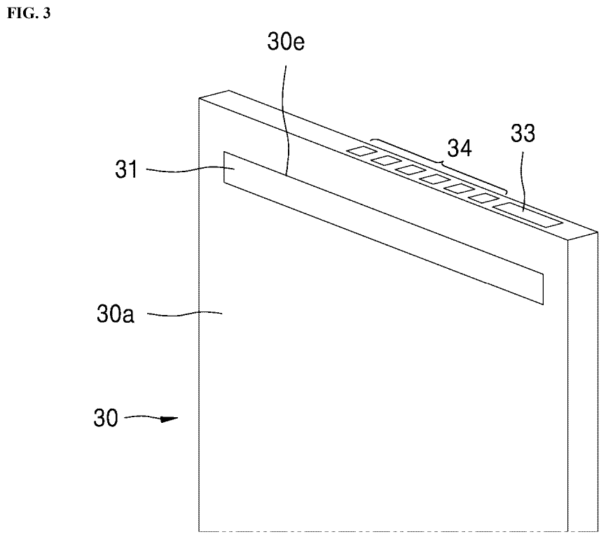

A detailed configuration of the pop-up handle 31 will be described later with reference to FIG. 3 and subsequent drawings.

Although not shown, the rear panel defining the inside of the door 30 may further be provided with a detergent supply device for automatically supplying detergent into the inside of the tub 20.

Furthermore, a door position sensor 36 may be disposed on an outer top surface of the tub 20 and may be configured to detect whether the door 30 is in a closed or open state. For example, the door position sensor 36 may include a door position sensor S_d or a latch sensor that detects a position of a door latch (not shown).

In one example, a drying air supply 80 may be disposed at the lower portion of the tub 20 and may be configured to generate and supply high-temperature or low-temperature drying air to the washing space 21 inside the tub 20.

As shown, the drying air supply 80 may be configured to include a filter member 883 for filtering outside air, a blower fan 825 for generating a drying air stream, a heater 84 for heating the drying air stream, and an air stream guide 83 disposed inside the tub 20 so as to guide the drying air stream.

A drying air supply hole may be defined in a lower surface of the tub 20 so that high-temperature drying air generated by the drying air supply 80 may be introduced into the inside of the tub 20 through the drying air supply hole.

Thus, the high-temperature drying air or low-temperature drying air may be supplied from the drying air supply 80 into the inside of the tub 20 during the drying cycle such that the drying efficiency and sterilization effect on the dishes may be significantly improved compared to a conventional dish washer.

In one example, the dish washer may be configured such that the air current supplied to the inside of the tub 20 and moistened while drying the dishes may be discharged to the outside, and the discharge of the air current may be accomplished via partial opening of the door 30 or via a separate air discharge means (not shown).

### Appearance and Operation of Pop-Up Handle

Hereinafter, with reference to FIGS. 3 to 5, the appearance and the operation of the pop-up handle 31 disposed at the door 30 of the dish washer 1 according to one embodiment of the present disclosure will be described in detail.

Hereinafter, a description will be made based on an embodiment in which the pop-up handle 31 and related components of the pop-up handle 31 are disposed inside the door 30 constituting the dish washer 1 as an example.

However, the present disclosure may not be limited thereto. Further, the pop-up handle 31 and the related components of the pop-up handle 31, which will be described later, may be similarly applied to home appliances such as an oven, a refrigerator, a dryer, a washing machine, or a laundry management apparatus configured such that an inner space of a casing performing a specific function is opened and closed through a door.

However, such oven, refrigerator, dryer, washing machine, or laundry management apparatus are configured to operate under different operating conditions and operating environments with different purposes and functions from the dish washer 1 according to the present disclosure.

In particular, because the oven operates in a high-temperature environment, the pop-up handle and a handle driver should be made of a material that may withstand high temperatures. In addition, the door of the oven may secure a space in which the pop-up handle and the handle driver are to be installed, but because a glass material that is partially resistant to heat is used, the pop-up handle and the handle driver need to be harmonized with the glass material, and a means for ensuring durability and safety in the high-temperature environment may be further added.

In one example, in the refrigerator, a shelf, a storage space, an insulator, and the like are included inside the door, so that space utilization may be restricted.

Therefore, to install the pop-up handle and the handle driver, it may be necessary to redesign an internal structure of the door or secure a space that may be installed without interference to the existing structure. In addition, in case of the refrigerator, because the pop-up handle is located in the door that is frequently opened and closed, durability and waterproof design may be essential.

In consideration of this, a motor or an electronic component that drives the pop-up handle may be disposed in an empty space defined inside the door of the refrigerator, and needs to be designed to be compatible with a power supply structure of the refrigerator. However, a design may be required to prevent interference with the insulator and the shelf structure inside the door, and a means considering waterproofing and durability may be added.

In one example, the dryer is in an environment exposed to high temperature and moisture. The pop-up handle and the handle driver should be made of a material that may withstand the high temperatures, and a means for preventing damage from internal heat of the dryer needs to be added.

In one example, in case of the washing machine, a tub into which water, detergent, and laundry are put is disposed at the rear of the door. Therefore, when the pop-up handle and the handle driver are installed in the door of the washing machine, because there is a high possibility of exposure to water and detergent, waterproof and dustproof design may be essential. In particular, the handle driver should be installed in a sealed space such that an electric motor or an electronic component is not exposed to water, and a means for securing durability needs to be added via the waterproof and dustproof design.

In one example, because the laundry management apparatus includes a steam function, moisture may penetrate into the door. Therefore, the pop-up handle and the handle driver should be resistant to moisture and should be designed in a sealed structure such that water does not penetrate thereinto. Therefore, waterproof and moisture-proof means need to be added to ensure durability in the steam environment.

Considering such operating environments and operating conditions, because the washing machine, the styler, and the dryer are highly likely to be exposed to water and moisture, the sealed structure may be essential for the pop-up handle and the handle driver.

In addition, because the dryer and the oven need to operate in the high temperature environment, the pop-up handles and the handle drivers thereof should be made of the heat-resistant material.

In addition, the motor or the electronic component that drives the handle driver should be disposed by efficiently utilizing the inner space of the door, and may be designed so as not to cause inconvenience to the user. Furthermore, the pop-up handle and the handle driver need to be equipped with a means for user's safety and injury prevention, and need to be equipped with a means for the user to manually open the door even in an event of a malfunction.

In particular, hereinafter, a description will be made based on a configuration in which the pop-up handle 31 is disposed to be elongated in parallel with the top surface of the door 30 along a left-right direction in consideration of an opening and closing direction of the door 30 of the dish washer 1, but in a case of home appliances to which the opening and closing direction of the door 30 is applied differently, such as the refrigerator and the laundry management apparatus, the pop-up handle 31 may be disposed in the door such that a longitudinal direction of the pop-up handle 31 is parallel to a vertical direction.

As described above, the pop-up handle 31 may be disposed in the door 30 of the dish washer 1 according to an embodiment of the present disclosure so as to reciprocate in a front-rear direction.

In this regard, as described above, the door 30 may be configured to be pivotable around the hinge (not shown) connected to a lower end of the door.

However, the present disclosure is not limited thereto, and a drawer-type door configured to be opened and closed in a simple horizontal movement manner along the front-rear direction (a F-R direction) is also applicable. Hereinafter, as illustrated, a description will be made based on an embodiment including the door 30 opened and closed while pivoting around the hinge connected to the lower end thereof.

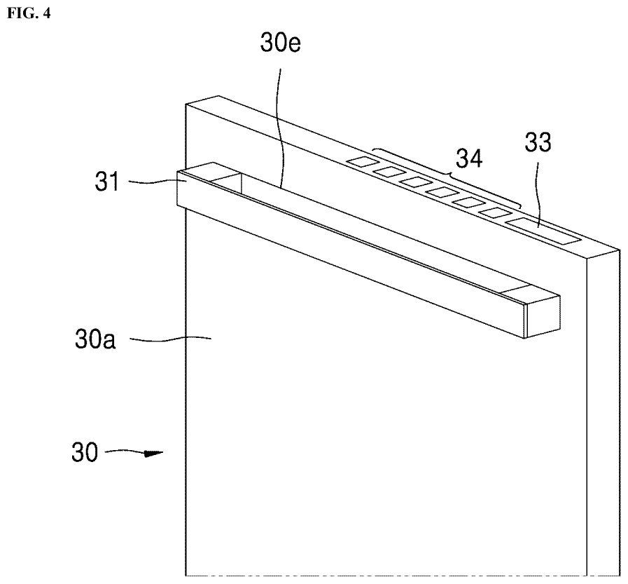

In consideration of this, as shown in FIG. 3 and FIG. 4, the pop-up handle 31 may be positioned at a position as close as possible to the top surface of the door 30 where the user may easily grip the handle.

Further, the pop-up handle 31 may be disposed so as to be retractable and extendable by passing through the front panel 30a forming the front surface of the door 30.

Further, the pop-up handle 31 may be disposed in parallel with the top surface of the door 30 along the left-right direction to facilitate the user's grip.

Further, the pop-up handle 31 may be formed to generally have a ⊏-shaped outer appearance to facilitate the user's grip.

As illustrated, in order to extend or retract the pop-up handle 31, an opening 30e having an elongated shape corresponding to the outer appearance of the pop-up handle 31 may be defined in the front panel 30a of the door 30 and extend along the extension direction of the front edge of the top surface of the door 30, and have a depth along a front-rear (F-R) direction.

The pop-up handle 31 may be configured to reciprocate in the forward and rearward directions through the opening 30e of the front panel 30a along the front-rear (F-R) direction under an operation of a handle driver 35 as will be described later.

More specifically, the pop-up handle 31 may be disposed to reciprocate in the forward and rearward directions between the most forward position and the most rearward position under the operation of the handle driver 35.

For convenience, the most forward position to which the pop-up handle 31 is displaced in a forward direction is defined as an extended position Pd. The most rearward position to which the pop-up handle 31 is displaced in a rearward direction is defined as a retracted position Pa.

FIG. 3 illustrates a state where the pop-up handle 31 has been displaced to the most rearward position, that is, the retracted position Pa, and thus has been retracted into the inside of the door 30.

As shown, when the pop-up handle 31 has been displaced to the retracted position Pa, the pop-up handle 31 may be in a state of being entirely or partially retracted into the inside of the door 30.

In this regard, illustratively, the pop-up handle 31 may pass through an entirety of the opening 30e of the door 30 and be retracted into the inside of the door 30.

Furthermore, when the pop-up handle 31 has been displaced to the retracted position Pa, the pop-up handle 31 may be in a state where the pop-up handle 31 does not protrude from the front panel 30a of the door 30 in a frontward direction.

Furthermore, when the pop-up handle 31 has been displaced to the retracted position Pa, a front end surface of the pop-up handle 31 may be coplanar with a front surface of the front panel 30a of the door 30 so as to form a continuous surface.

That is, the front end surface of the pop-up handle 31 at the retracted position Pa may be in a state parallel to the front panel 30a.

Therefore, a state in which no step is formed between the front surface of the front panel 30a of the door 30 and the front end surface of the pop-up handle 31 may be formed.

Thus, when the pop-up handle 31 has been displaced to the retracted position Pa, the opening 30e of the front panel 30a may bs entirely blocked.

Further, when the pop-up handle 31 has been displaced to the retracted position Pa, no step is formed between the front surface of the front panel 30a and the front end surface of the pop-up handle 31, such that the phenomenon in which foreign substances such as dust accumulate on an convex portion formed at the front surface of the door 30 or on the handle itself as in the conventional approach may be fundamentally prevented.

In one example, as will be described later, the front end surface of the pop-up handle 31 may be a front surface of a decoration panel 317 that is provided separately from a first handle body 311, a second handle body 3112, and a third handle body 3113 that constitute the outer appearance of the pop-up handle 31.

In this regard, the front surface of the decoration panel 317 may include a material having the same texture and the same color as those of the front panel 30a of the door 30.

Accordingly, a sense of unity between the decoration panel 317 and the front panel 30a of the door 30 may be generated.

In addition, aesthetic sensibility of the outer appearance of the door 30 may be improved, and aesthetics of the door which the user perceives may be improved.

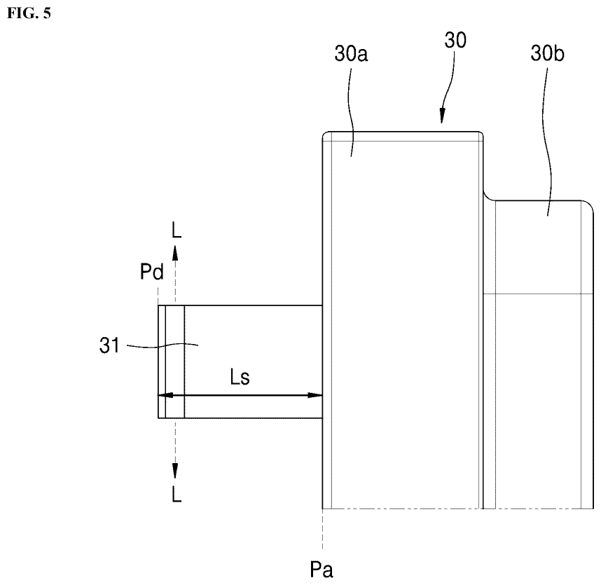

FIG. 4 and FIG. 5 illustrate a state in which the pop-up handle 31 has been displaced from the retracted position Pa to the extended position Pd as the most forward position.

The door 30 of the dish washer 1 should be opened and closed in order to store the dishes that need to be washed in the dish washer or to withdraw the dishes that have been washed out of the dish washer 1.

When the user's intention to open the door 30 is identified at a time when opening/closing of the door 30 is required, the pop-up handle 31 may be automatically moved from the retracted position Pa to the extended position Pd under the operation of the handle driver 35.

To this end, the dish washer 1 according to an embodiment of the present disclosure may further be provided with a means for detecting the user's intention to open the door 30.

For example, the means for detecting the user's intention to open the door 30 may include a proximity sensor (not shown).

The proximity sensor may be a sensor that may detect whether the user approached so as to be located within a specific range from the door 30.

For example, the proximity sensor may include any one of a radar sensor, an image sensor, or an infrared (IR) sensor.

To effectively identify whether the user is in proximity, the proximity sensor may be disposed on at least one of the top surface, a bottom surface, and the front surface of the door 30.

Further, a means for detecting the user's intention to open the door 30 may include a touch sensor (not shown).

Illustratively, the touch sensor may include any one of capacitive type, resistive type, and pressure type touch sensors.

The touch sensor may be disposed in the pop-up handle 31 so as to effectively identify the intention to open or close the door 30.

Illustratively, the touch sensor may be mounted on a handle substrate 314 together with a lighting element 315 as will be described later.

When the user's intention is identified, the pop-up handle 31 may be automatically moved forward to the extended position Pd as shown in FIGS. 4 and 5.

When the movement of the pop-up handle 31 to the extended position Pd is completed as described above, a state in which the first handle body 311 constituting the pop-up handle 31 is entirely exposed to the outside of the door 30 may be formed.

Further, when the movement of the pop-up handle 31 to the extended position Pd is completed, a state in which the user is able to grip the handle may be formed.

In this regard, a stroke Ls in which the pop-up handle 31 is moved from the retracted position Pa to the extended position Pd may be, for example, equal to or greater than 40 mm and equal to or smaller than 50 mm.

Preferably, the stroke Ls in which the pop-up handle 31 is moved from the retracted position Pa to the extended position Pd may be 45 mm.

Determination of the stroke Ls of the pop-up handle 31 as such is made in consideration of the fact that it is not easy for the user to grip the pop-up handle 31 when the stroke Ls is too small, such as smaller than 40 mm, and the fact that a size of the pop-up handle 31 in the front-rear direction is increased and thus the pop-up handle 31 is not entirely retracted into the door 30 when the stroke Ls is too great, such as exceeding 50 mm.

However, the movement stroke Ls of the pop-up handle 31 as such is merely an example, and may be set differently depending on an overall size of the dish washer 1 and a size in the front-rear direction of the door 30.

In one example, as the pop-up handle 31 is moved to the extended position Pd, the first handle body 311 of the pop-up handle 31 may exit the opening 30e of the front panel 30a of the door 30 and be entirely exposed and protrude to the outside of the door 30.

Accordingly, the closed state of the opening 30e of the front panel 30a is at least partially released by the pop-up handle 31.

However, as will be described later, when the pop-up handle 31 is moved to the extended position Pd, a blind panel of a blind module 37 is moved forward together in association with the first handle body 311.

Accordingly, the opening 30e of the front panel 30a that is opened based on the movement of the pop-up handle 31 may be shielded by the blind module 37.

Accordingly, even when the pop-up handle 31 is moved to the extended position Pd, the opening 30e of the front panel 30a may be maintained in the closed state or the shielded state.

Accordingly, the foreign substances such as dust may be effectively prevented from passing through the opening 30e and being introduced into the door 30.

Further, observation of the inside of the door 30 through the opening 30e of the front panel 30a becomes unavailable by the blind module 37.

Accordingly, deterioration of the aesthetics of the door which the user perceives may be effectively prevented.

In addition, as illustrated in FIG. 5, the pop-up handle 31 may be configured such that the user may visually recognize that the pop-up handle 31 is normally being driven or that the pop-up handle 31 is in operation.

To this end, as will be described later, the pop-up handle 31 may include a handle illuminator 314, 315, and 316 that generates visible light L from the inside of the pop-up handle 31 and irradiates the visible light L toward the outside of the pop-up handle 31.

As shown, the visible light L generated from the handle illuminator 314, 315, and 316 inside the pop-up handle 31 may be irradiated outward through a light emitting surface forming a portion of an outer surface of the pop-up handle 31.

The light emitting surface may be continuously formed with respect to an upper surface, a lower surface, and both side surfaces of the pop-up handle.

In addition, a width of the entire light emitting surface in the front-rear direction (the F-R direction) may be uniform.

As will be described later, the light emitting surface may be an outer edge surface of a light guide plate 316 constituting the handle illuminator 314, 315, and 316.

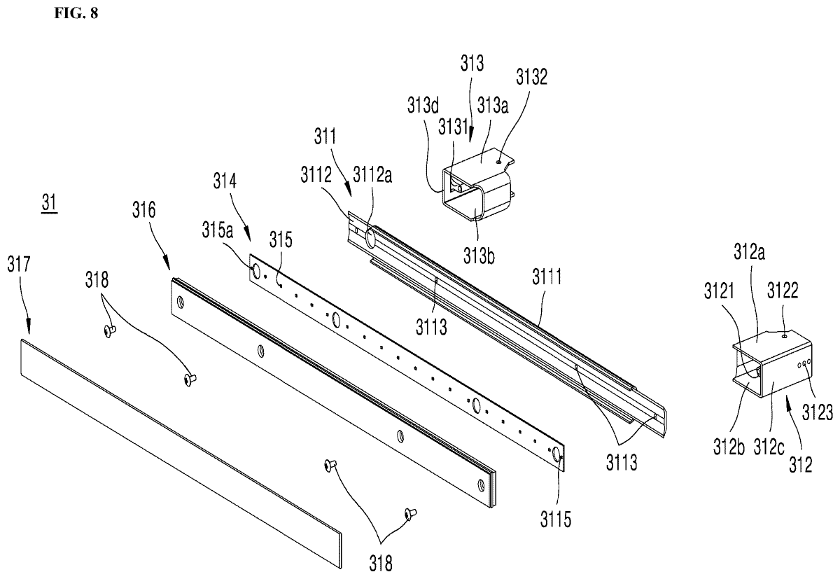

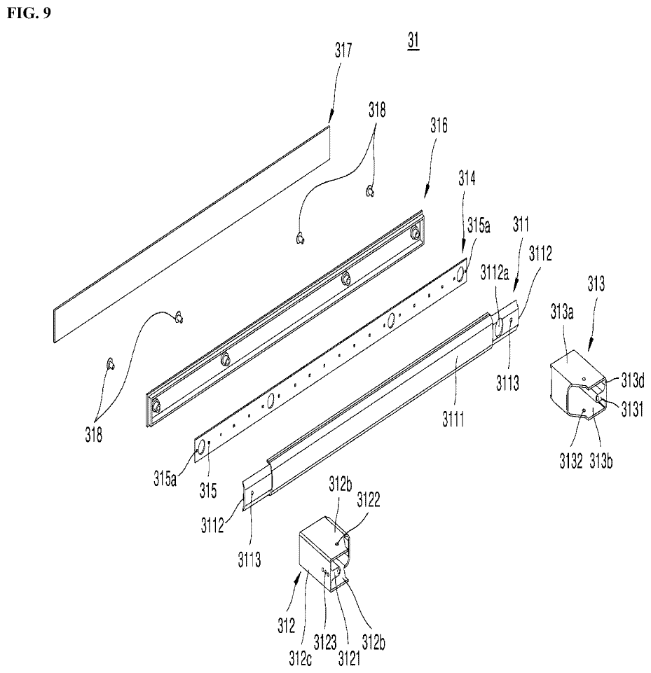

A detailed configuration of the handle illuminator 314, 315, and 316 will be described later with reference to FIG. 8 and subsequent drawings.

### Detailed Configuration of Pop-Up Handle

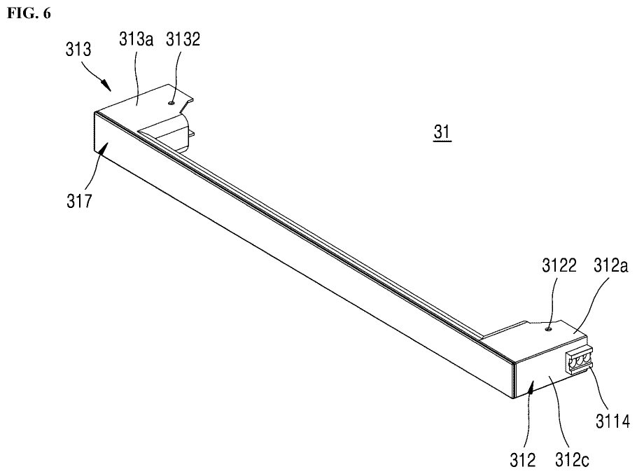

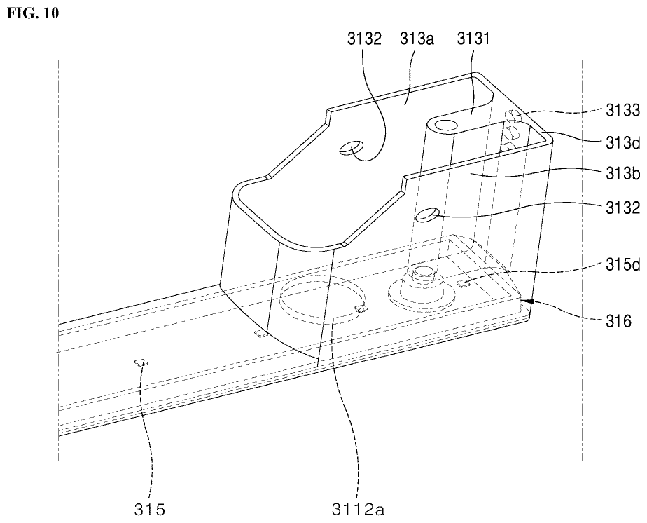

FIGS. 6 to 10 show a detailed configuration of the pop-up handle 31 of the dish washer 1 according to an embodiment of the present disclosure.

Hereinafter, the detailed configuration of the pop-up handle 31 will be described with reference to FIGS. 6 to 10.

First, as shown in FIGS. 6 to 9, the pop-up handle 31 may include the first handle body 311 that protrudes entirely to the outside of the door 30 during the forward and horizontal movement toward the extended position Pd.

The first handle body 311 may horizontally extend along the left-right direction (a Le-Ri direction).

As described above, when the movement to the extended position Pd is completed, the first handle body 311 corresponds to a portion gripped by the user to open and close the door 30.

Therefore, when being gripped by the user for the opening/closing operation of the door 30, the first handle body 311 may receive a significantly great load.

In consideration of the great load applied to the first handle body 311, the first handle body 311 may be formed via an extrusion molding process of a lightweight metal material, for example, an aluminum material.

Further, an outer surface of a grip portion 3111 of the first handle body 311 corresponding to a portion gripped by the user needs to increase the user's grip.

To this end, an edge of the outer surface of the grip portion may be chamfered to form a smooth curved surface.

Further, the first handle body 311 serves to at least partially accommodate the handle illuminator 314, 315, and 316 to be described later therein and to support the handle illuminator 314, 315, and 316.

In the illustrated embodiment, a configuration in which the first handle body 311 is disposed at a rear side and the handle illuminator 314, 315, and 316 is coupled to a front portion of the first handle body 311 is illustrated. However, the present disclosure is not limited thereto, and a configuration in which the first handle body 311 is disposed at a front side and the handle illuminator 314, 315, and 316 is disposed at the rear of the first handle body 311 and coupled to a rear portion of the first handle body 311 is also applicable. Hereinafter, a description will be made based on the configuration in which the handle illuminator 314, 315, and 316 is disposed in front of the first handle body 311 and coupled to the front portion of the first handle body 311 as in the illustrated embodiment.

A front surface of the first handle body 311 may be entirely open such that the handle illuminator 314, 315, and 316 may be coupled thereto and accommodated thereinto from the front.

Furthermore, an accommodation space concavely recessed rearwards may be defined inside the first handle body 311 such that the handle illuminator 314, 315, and 316 may be partially accommodated therein.

As will be described later, the handle illuminator 314, 315, and 316 may be fastened and fixed to the first handle body 311 using a plurality of screw bolts 318.

A plurality of fastening holes 3113 to which the individual screw bolts 318 are screwed may be defined in the first handle body 311.

In the embodiment, a total of four screw bolts 318 are disposed, and a total of four fastening holes 3113 are defined in the first handle body 311 in response thereto.

However, this is merely exemplary, and the number of screw bolts 318 and the number of fastening holes 3113 may be set differently depending on the size of the pop-up handle 31 and the load acting on the pop-up handle 31.

In one example, screw bolts 318 disposed at the outermost sides in the left-right direction (the Le-Ri direction) among the plurality of screw bolts 318 may further perform a function of fastening both the handle illuminator 314, 315, and 316 and the first handle body 311 to the second handle body 312 and the third handle body 313, respectively, in addition to the function of fastening the handle illuminator 314, 315, and 316 to the first handle body 311.

To this end, fastening holes 3113 disposed at the outermost sides in the left-right direction (the Le-Ri direction) may be defined to extend through the first handle body 311 along the front-rear direction (the F-R direction).

Further, the first handle body 311 may serve to reflect the visible light L generated from the lighting element 315 of the handle illuminator 314, 315, and 316 to be described later and evenly distribute the visible light L therein.

To this end, an inner surface 311a of the first handle body 311 may include a reflective surface formed to face the handle illuminator 314, 315, and 316.

As will be described later, the reflective surface of the first handle body 311 may be configured as a composite surface including at least one flat portion or at least one curved portion.

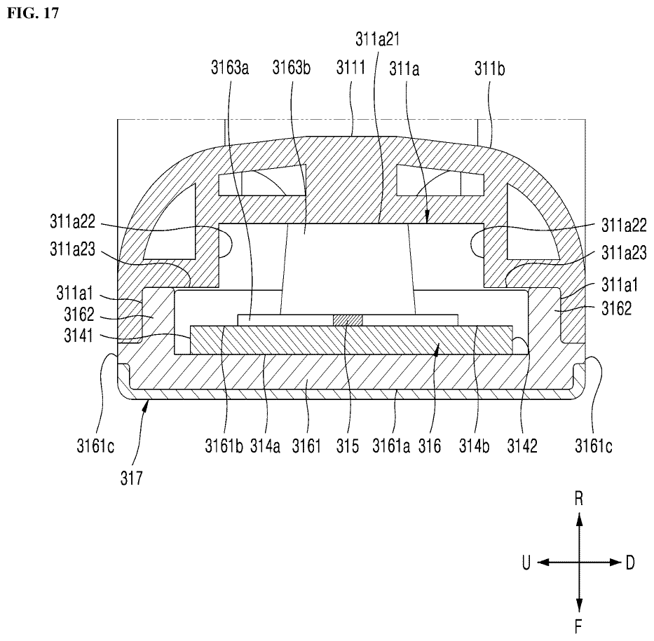

A detailed configuration of the inner surface 311a of the first handle body 311 having the reflective surface will be described later with reference to FIGS. 17 to 22.

In one example, the pop-up handle 31 may include the second handle body 312 and the third handle body 313 fastened to both ends of the first handle body 311, respectively.

More specifically, the pop-up handle 31 may further include the second handle body 3112 connected to a left end of the first handle body 311 and extending rearwards.

Further, the pop-up handle 31 may further include the third handle body 3113 connected to a right end of the first handle body 311 and extending rearwards.

The second handle body 312 and the third handle body 313 may be connected and fastened to a coupling portion 3112 formed at the left end of the first handle body 311 and a coupling portion 3112 formed at the right end of the first handle body 311, respectively.

The second handle body 312 and the third handle body 313 serve to receive the driving force in the front-rear direction (the F-R direction) of the handle driver 35 and transmit a load of the user for the opening/closing operation of the door 30 to the door 30.

In consideration of great loads applied to the second handle body 312 and the third handle body 313, the second handle body 312 and the third handle body 313 may be formed via the extrusion molding process of the lightweight metal material, for example, the aluminum material, like the first handle body 311.

In this regard, to minimize weights of the second handle body 312 and the third handle body 313, the second handle body 312 and the third handle body 313 may be formed in a hollow cylindrical shape in which a front end and a rear end are entirely open based on a state in which they are disposed in the door 30.

As described above, the screw bolt 318 disposed at the leftmost side in the left-right direction (the Le-Ri direction) among the plurality of screw bolts 318 fastens both the handle illuminator 314, 315, and 316 and the first handle body 311 to the second handle body 312.

The second handle body 3112 may include a screw boss 3121 extending linearly along the front-rear direction (the F-R direction) therein such that the screw bolt 318 may be fastened thereto via screwing.

In this regard, to prevent a decrease in strength of the second handle body 312 itself and increase a fastening strength with respect to the first handle body 311, a screw boss 3163 may be formed as a plate-shaped rib protruding from a left side surface of the second handle body 312 along a horizontal direction.

A fastening hole into which the screw bolt 318 is screwed may be defined by extending through an inner end of the screw boss 3163 along the front-rear direction (the F-R direction).

Furthermore, a plurality of screw holes 3123 for fastening a guide block 3114 to be described later may be defined through the second handle body 312.

In this regard, the plurality of screw holes 3123 may pass through a left side surface 312c of the second handle body 312 and extend to the inside of the screw boss 3163.

As the screw hole 3123 extends to the inside of the screw boss 3163 as described above, minimum fastening strength and fastening depth for the guide block 3114 may be secured.

As described above, the pop-up handle 31 is configured to receive a linear driving force in the front-rear direction (the F-R direction) of the handle driver 35 via the second handle body 312.

More specifically, for example, the second handle body 312 is connected to a first link 354a of the handle driver 35 and receives the linear driving force in the front-rear direction (the F-R direction) via the first link 354a.

In this regard, the first link 354a may be configured to transmit the linear driving force in the front-rear direction (the F-R direction) in a state of being connected to the second handle body 312 so as to be relatively rotatable via a moving pin (not shown).

To this end, a pin hole 3122 into which an upper end of the moving pin is inserted and coupled may be defined through an upper surface 312a of the second handle body 312 in a vertical direction (a U-D direction).

Further, a pin hole 3122 into which a lower end of the moving pin is inserted and coupled may be defined through a lower surface 312b of the second handle body 312 in the vertical direction (the U-D direction).

As illustrated, the pin hole 3122 may be defined at a position as close as possible to a rear end of the second handle body 312 so as not to be exposed to the outside during the forward movement of the handle to the extended position Pd without interfering with the operation of the first link 354a.

In one example, the third handle body 313 may have a shape symmetrical to the second handle body 312 with respect to a vertical surface that divides the first handle body 311 in a left-right direction (the Le-Ri direction), and may be disposed at a position symmetrical thereto.

Therefore, in relation to the third handle body 313, a configuration including pin holes 3132 defined through an upper surface 313a and a lower surface 313b, respectively, and a detailed configuration of a plate-shaped screw boss 3131 integrally protruding from a right side surface 313d and extending inwards may be provided at positions symmetrical to those of the second handle body 312, in shapes symmetrical thereto.

As the third handle body 313 is disposed at the position symmetrical to the second handle body 312 and formed in the shape symmetrical thereto, a description of redundant contents regarding the third handle body 313 will be omitted below.

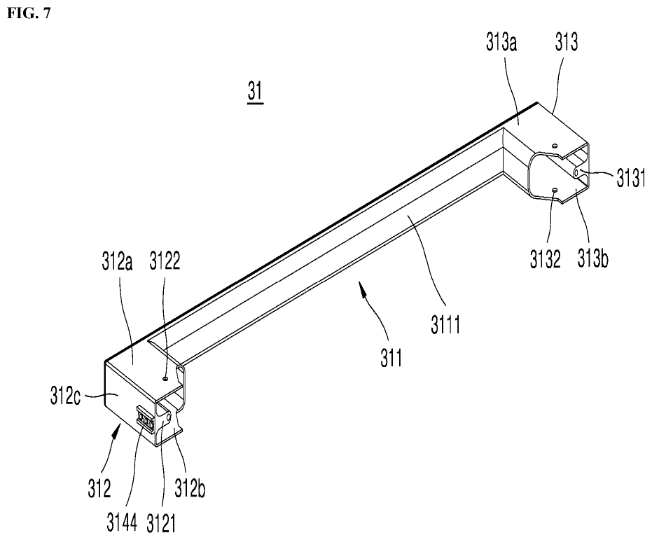

In one example, as illustrated in FIGS. 6 and 7, the pop-up handle 31 may include the guide block 3114 attached to each of the left side surface 312c of the second handle body 3112 and the right side surface 313d of the third handle body 3113.

The guide block 3114 is inserted into a guide bracket 30h1 and 30h2 of the handle frame 30d to be described later, and serves to guide the forward and rearward reciprocating movement of the handle frame 30d.

Further, the guide block 3114 may serve as a stopper for preventing the pop-up handle 31 from additionally moving frontwards after the movement to the extended position Pd is completed.

Further, it may also serve to absorb loads or impacts of the user acting on the second handle body 3112 and the third handle body 3113 of the pop-up handle 31 to open the door 30 after the pop-up handle 31 is moved to the extended position Pd.

In consideration thereof, the guide block 3114 may be made of an elastic material having predetermined elasticity.

The guide blocks 3114 may be fastened and fixed to the left side surface 312c of the second handle body 312 and the right side surface 313d of the third handle body 313, respectively, via a fastening means such as a screw bolt.

As described above, the plurality of screw holes 3123 for fastening the guide block 3114 may be defined through the left side surface 312c of the second handle body 312.

Further, a plurality of screw holes 3133 for fastening the guide block 3114 may be defined through the right side surface 313d of the third handle body 313.

In one example, as described above, the pop-up handle 31 of the dish washer 1 according to an embodiment of the present disclosure may include the handle illuminator 314, 315, and 316 that allows the user to visually recognize that the pop-up handle 31 is being normally driven or that the pop-up handle 31 is in operation.

For example, as described above, the handle illuminator 314, 315, and 316 may be configured to generate the visible light L from the inside of the pop-up handle 31 and irradiate the visible light L toward the outside through the light emitting surface of the pop-up handle 31.

First, the handle illuminator 314, 315, and 316 may include a plurality of lighting elements 315 that are disposed in front of the first handle body 311 and generate the visible light L.

The lighting element 315 may be applied without limitation as long as it is a means capable of receiving the power and generating the predetermined visible light L, and may be, for example, an LED element.

FIGS. 8 and 9 exemplarily illustrate an embodiment in which a total of 20 lighting elements 315 are disposed. The number of lighting elements 315 may be set differently depending on positions where the lighting elements 315 are arranged and a shape in which the lighting elements 315 are arranged, as will be described later.

In this regard, the lighting elements 315 may have the same size and shape.

Accordingly, the lighting elements 315 may be mounted on the handle substrate 314 so as to be interchangeable with each other.

Further, the handle illuminator 314, 315, and 316 may include the handle substrate 314 disposed in front of the first handle body 311.

As illustrated, the plurality of lighting elements 315 may be mounted on one side surface of the handle substrate 314.

To minimize the size of the pop-up handle 31 in the front-rear direction (the F-R direction), the handle substrate 314 may be disposed such that a thickness direction thereof is parallel to the front-rear direction (the F-R direction).

Further, the pop-up handle 31 may have a rectangular shape in which the left-right direction (the Le-Ri direction) becomes a longitudinal direction, corresponding to a shape of the first handle body 311.

Accordingly, the lighting elements 315 may be arranged in an elongated manner along the longitudinal direction of the first handle body 311.

The plurality of lighting elements 315 may be mounted on a front surface 314a of the handle substrate 314 or a rear surface 314b of the handle substrate 314, based on a state in which the lighting elements are disposed in front of the first handle body 311.

In this regard, as will be described later, the plurality of lighting elements 315 may be mounted and arranged on the rear surface 314a of the handle substrate 314 such that the visible light L may be irradiated toward the inner surface 311b of the first handle body 311 functioning as the reflective surface.

The handle substrate 314 is fixed to and supported by a rear surface of the light guide plate 316 disposed in front of the same.

More specifically, the handle substrate 314 may be supported by screw bosses 3163 disposed on the light guide plate 316, and may be prevented from deviating by the screw bosses 3163.

As illustrated, the handle substrate 314 may include a plurality of through holes 314h defined at positions corresponding to the screw bosses 3163 of the light guide plate 316 and defined to extend through the handle substrate 314 from the front surface 314a to the rear surface 314b.

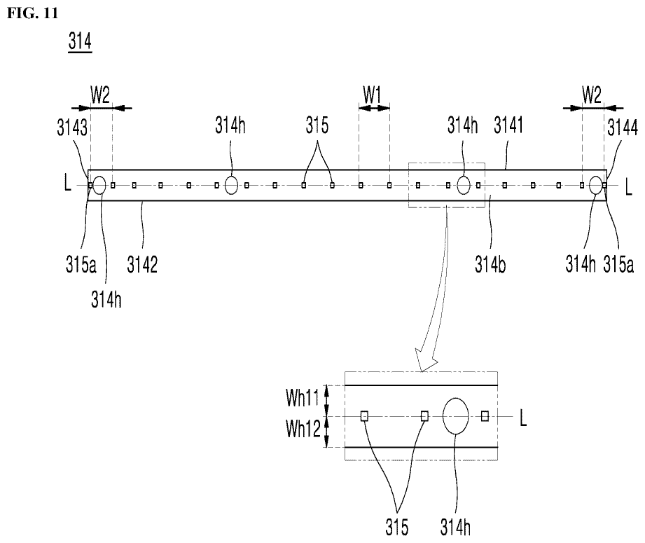

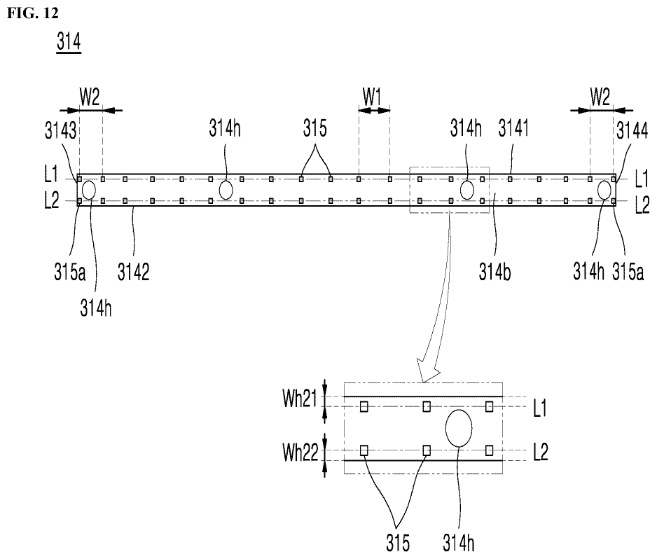

A detailed configuration of the lighting elements 315 and the handle substrate 314 will be described later with reference to FIGS. 11 and 12.

In addition, the handle illuminator 314, 315, and 316 may include the light guide plate 316 that is disposed in front of the handle substrate 314 and diffuses the visible light L generated from the plurality of lighting elements 315.

The light guide plate 316 serves to diffuse the visible light L generated from the lighting elements 315 and emit the visible light L to the outside of the pop-up handle 31 through the light emitting surface.

More specifically, based on the illustrated embodiment, the visible light L generated from the lighting elements 3131 may be introduced into a rear side of the light guide plate 316, then be uniformly dispersed inside the light guide plate 316, and then be diffused toward an outer edge surface 3161c of the light guide plate 316, which is the light emitting surface.

The light guide plate 316 may be formed via injection molding of a plastic material having predetermined light transmittance such that the visible light L is effectively incident thereon and uniformly diffused therein.

For the same reason as the handle substrate 314, the light guide plate 316 may be disposed in front of the first handle body 311 such that the thickness direction thereof is parallel to the front-rear direction (the F-R direction).

In one example, the light guide plate 316 may also function to accommodate the handle substrate 314 therein and support the same.

To this end, as will be described later, the light guide plate 316 may include an accommodating portion defining rib 3162 disposed in a form of a barrier surrounding an entire periphery of the handle substrate 314.

In addition, as described above, the light guide plate 316 is fixed to and supported by the first handle body 311 via the plurality of screw bolts 318 together with the handle substrate 314.

To this end, the light guide plate 316 may include the screw boss 3163 protruding from the rear surface thereof toward the first handle body 311.

The individual screw boss 3163 may be a hollow boss such that the individual screw bolt 318 may pass therethrough and extend to the fastening hole 3113 of the first handle body 311.

Further, the individual screw boss 3163 of the light guide plate 316 may pass through the through hole 314h of the handle substrate 314 and extend rearwards.

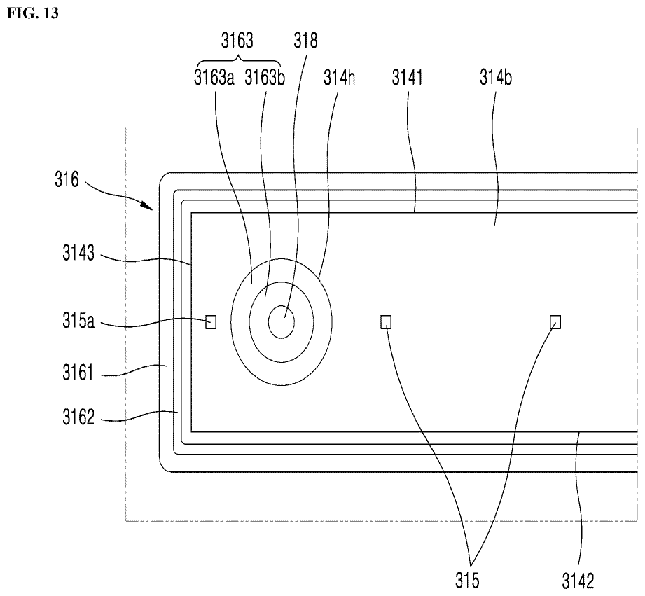

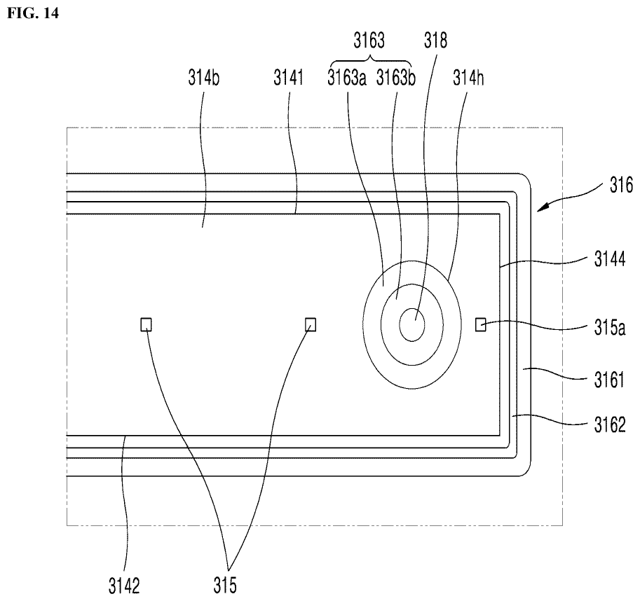

A detailed configuration of the light guide plate 316 including the accommodating portion defining rib 3162 and the screw boss 3163 will be described later with reference to FIGS. 13 and 14.

In one example, as described above, the pop-up handle 31 may include the decoration panel 317 disposed in front of the light guide plate 316 and disposed to entirely cover the front surface of the light guide plate 316.

As described above, the decoration panel 317 is made of a metal material having a predetermined thickness and is surface-treated to have the same texture as the front panel 30a of the door 30.

Accordingly, the visible light L introduced into the light guide plate 316 may not pass through the decoration panel 317 and may be reflected by a rear surface of the decoration panel 317 to be re-diffused inside the light guide plate 316.

In one example, the lighting element 315 constituting the handle illuminator 314, 315, and 316 receives the power from the outside of the pop-up handle 31 and generates the visible light L.

To this end, the handle substrate 314 on which the lighting element 315 is mounted may be electrically connected to a cable (not shown), and is configured to receive the power through the cable.

A cable hole 3112a may be defined through the first handle body 311 along the front-rear direction (the F-R direction) such that the cable for supplying the power to the handle substrate 314 may pass therethrough.

The cable hole 3112a may be defined in any one of the left coupling portion 3112 and the right coupling portion 3112 of the first handle body 311.

In the embodiment illustrated in FIGS. 8 to 10, a configuration in which the cable hole 3112a is defined in the right coupling portion 3112 of the first handle body 311 is exemplarily illustrated.

As described above, as the cable hole 3112a is defined in the right coupling portion 3112 of the first handle body 311, the cable hole 3112a may be in communication with an inner space of the third handle body 313.

Accordingly, the cable that has passed through the cable hole 3112a of the first handle body 311 may pass through the inner space of the third handle body 313 and extend toward the inside of the door 30.

The cable extending toward the inside of the door 30 may be electrically connected to a driver control board 357 to be described later.

### Detailed Configuration of Arrangement Structure of Handle Substrate and Lighting Elements

Hereinafter, an arrangement structure of the handle substrate 314 constituting the handle illuminator 314, 315, and 316 of the dish washer 1 according to an embodiment of the present disclosure and the lighting elements 315 mounted on the handle substrate 314 will be described with reference to FIGS. 12 and 13.

As described above, the plurality of lighting elements 315 may be arranged on the rear surface 314b of the handle substrate 314 so as to be interchangeable with each other.

In this regard, as illustrated in FIG. 13, the plurality of lighting elements 315 may be arranged linearly and in a row along a single line L extending in the left-right direction (the Le-Ri direction).

As described above, as the plurality of lighting elements 315 are arranged in a row, the number of plurality of lighting elements 315 disposed may be minimized.

In this regard, the single line L in which the plurality of lighting elements 315 are arranged may be a line that equally divides the handle substrate 314 based on the vertical direction (the U-D direction).

Further, the single line L in which the plurality of lighting elements 315 are arranged may be a line parallel to each of an upper edge 3141 of the handle substrate 314 and a lower edge 3142 of the handle substrate 314.

Accordingly, a first vertical spacing Wh11 from the lighting element 315 to the upper edge 3141 of the handle substrate 314 and a second vertical spacing Wh12 from the lighting element 315 to the lower edge 3142 of the handle substrate 314 may be set to be equal to each other.

Accordingly, the visible light L generated from the plurality of lighting elements 315 arranged along the single line L may be evenly distributed to the upper edge 3141 and the lower edge 3142.

Therefore, as will be described later, a vertical deviation of an amount of light emitted from the outer edge surface 3161c of the light guide plate 316 serving as the light emitting surface may be minimized.

In one example, left-right directional spacings W1 and W2 between respective pairs of lighting elements 315 disposed adjacent to each other among the plurality of lighting elements 315 may be uniform throughout the handle substrate 314.

Alternatively, the left-right directional spacings W1 and W2 between the respective pairs of lighting elements 315 disposed adjacent to each other among the plurality of lighting elements 315 may vary in a direction toward a left edge 3143 or a right edge 3144 of the handle substrate 314.

FIG. 11 exemplarily shows a configuration in which the left-right directional spacings W1 between the respective pairs of lighting elements 315 disposed adjacent to each other are kept the same except for a pair of lighting elements 315 disposed closest to the left edge 3143 of the handle substrate 314 and a pair of lighting elements 315 disposed closest to the right edge 3144 of the handle substrate 314.

In this regard, a left-right directional spacing W2 between a pair of lighting elements 315 disposed closest to the left edge 3143 of the handle substrate 314 and a left-right directional spacing W2 between a pair of lighting elements 315 disposed closest to the right edge 3144 of the handle substrate 314 may be the smallest.

Further, the left-right directional spacing W2 between the pair of lighting elements 315 disposed closest to the left edge 3143 of the handle substrate 314 and the left-right directional spacing W2 between the pair of lighting elements 315 disposed closest to the right edge 3144 of the handle substrate 314 may be set to be equal to each other.

The adjustment of the left-right directional spacings between the respective pairs of lighting elements 315 disposed adjacent to each other as such is in consideration of an overlapping effect of light emitted from the lighting elements 315 disposed close to a center of the handle substrate 314.

Therefore, as will be described later, a left-right directional deviation of an amount of light emitted from the outer edge surface 3161c of the light guide plate 316 serving as the light emitting surface may be minimized.

In one example, as described above, the plurality of through holes 314h may be defined through the handle substrate 314 along the thickness direction of the handle substrate 314.

The screw boss 3163 and the screw bolt 318 of the light guide plate 316, which will be described later, pass through the individual through hole 314h.

As illustrated, the individual through hole 314 h has a diameter that is about 50% of a width of the handle substrate 314 in the vertical direction.

Accordingly, there is a high possibility that the visible light L directed toward the left edge 3143 of the handle substrate 314 and the right edge 3144 of the handle substrate 314 is at least partially blocked by the screw boss 3163 and the screw bolt 318 passing through the through hole 314h, and accordingly, there is a very high possibility that a deviation in the amount of light occurs at the left edge 3143 of the handle substrate 314 and at the right edge 3144 of the handle substrate 314.

To minimize the deviation of the amount of light at the left edge 3143 of the handle substrate 314 and at the right edge 3144 of the handle substrate 314, as illustrated, at least one lighting element 315a among the plurality of lighting elements 315 may be disposed between the leftmost through hole 314h among the plurality of through holes 314h and the left edge 3143 of the handle substrate 314.

Further, for the same reason, at least one lighting element 315h among the plurality of lighting elements 315 may be disposed between the rightmost through hole 314h among the plurality of through holes 314a and the right edge 3144 of the handle substrate 314.

In one example, FIG. 12 illustrates a configuration in which the plurality of lighting elements 315 are linearly arranged in two rows along a first line L1 extending along the left-right direction (the Le-Ri direction) and a second line L2 extending in parallel with the first line L1 along the left-right direction (the Le-Ri direction) and located below the first line L1.

Such a configuration in which the plurality of lighting elements 315 are arranged in the two rows may be suitable when it is necessary to secure a relatively great amount of light or when the vertical width of the handle substrate 314 is relatively greater, compared to the above-described one-row arrangement configuration.

Even when the plurality of lighting elements are arranged in the two rows as described above, it is necessary to minimize the vertical deviation of the amount of light.

To this end, a first vertical spacing Wh21 between the upper edge 3141 of the handle substrate 314 and the first line L1 and a second vertical spacing Wh22 between the lower edge 3142 of the handle substrate 314 and the second line L2 may be equal to each other.

Further, to minimize the vertical deviation of the amount of light, similarly to the above-described configuration, a left-right directional spacing W2 between the pair of lighting elements 315 disposed closest to the left edge 3143 of the handle substrate 314 and a left-right directional spacing W2 between the pair of lighting elements 315 disposed closest to the right edge 3144 of the handle substrate 314 may be the smallest.

### Detail Configuration of Light Guide Plate

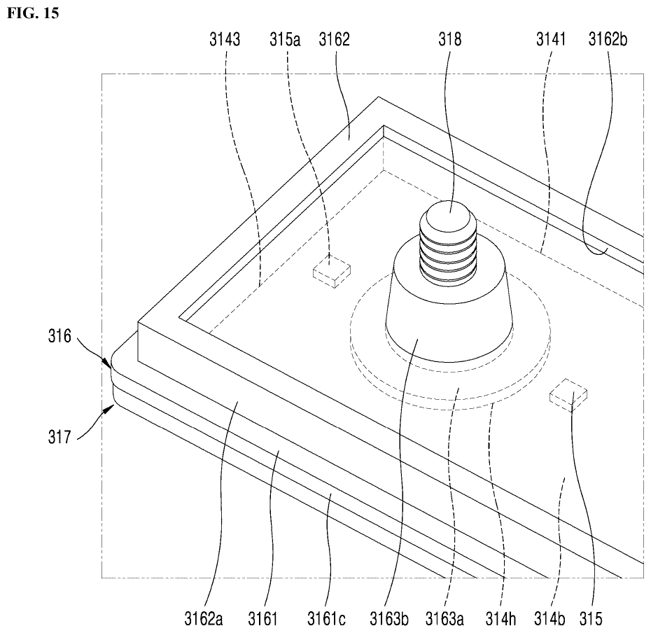

Hereinafter, a detailed configuration of the light guide plate 316 constituting the handle illuminator 314, 315, and 316 of the dish washer 1 according to an embodiment of the present disclosure will be described with reference to FIGS. 13 to 16.

As described above, the light guide plate 316 constituting the handle illuminator 314, 315, and 316 may serve to accommodate and support the handle substrate 314 therein in addition to serving to diffuse and disperse the visible light L generated from the plurality of lighting elements 315 and transmit the visible light L to the outside of the pop-up handle 31 via the outer edge surface 3161c.

First, the light guide plate 316 may include a main plate 3161 that transmits the visible light L to the outside of the pop-up handle 31.

To minimize the size of the pop-up handle 31 in the front-rear direction (the F-R direction), the main plate 3161 may be disposed such that a thickness direction thereof is parallel to the front-rear direction (the F-R direction).

Further, the main plate 3161 may have a rectangular shape in which the left-right direction (the Le-Ri direction) becomes a longitudinal direction, corresponding to the shape of the first handle body 311.

The main plate 3161 may be a plate-shaped member in which a thickness in the front-rear direction is substantially uniform.

As described above, the decoration panel 317 made of the metal material having light-impermeability is coupled to a front surface 3161a of the main plate 3161.

Accordingly, as the decoration panel 317 is coupled, the visible light L may be blocked from passing through the front surface 3161a of the main plate 3161 and being emitted to the outside.

For fitted engagement of the decoration panel 317, a step having a width corresponding to a thickness of the decoration panel 317 may be formed at an edge of the front surface 3161a of the main plate 3161.

The outer edge surface 3161c of the main plate 3161 may be exposed to the outside of the pop-up handle 31 and act as the light emitting surface.

A width of the outer edge surface 3161c in the front-rear direction may be uniform throughout the outer edge surface 3161c such that a uniform amount of light may be emitted to the outside through the outer edge surface 3161c serving as the light emitting surface.

Further, the light guide plate 316 may include the accommodating portion defining rib 3162 defining the accommodation space in which the handle substrate 314 is accommodated.

The accommodating portion defining rib 3162 may protrude rearwards from a rear surface 3161b of the main plate 3161 and may be integrally connected to the rear surface 3161b of the main plate 3161.

To define the accommodation space capable of accommodating the entire handle substrate 314 therein, the accommodating portion defining rib 3162 may be formed in a barrier shape that entirely surrounds the outer edge of the handle substrate 314.

As the accommodating portion defining rib 3162 protrudes from the rear surface 3161b of the main plate 3161, the accommodation space defined to be concave in the frontward direction may be defined inward of the accommodating portion defining rib 3162.

In this regard, a height at which the accommodating portion defining rib 3162 protrudes from the rear surface 3161b of the main plate 3161 may be approximately uniform throughout the main plate 3161.

However, to entirely accommodate the handle substrate 314, the height at which the accommodating portion defining rib 3162 protrudes from the rear surface 3161b of the main plate 3161 may be greater than the thickness of the main plate 3161.

However, as will be described later, the visible light L generated from the lighting element 315 is reflected by an inner surface of the first handle body 311 and then is incident on an inner peripheral surface 3162b of the accommodating portion defining rib 3162.

Because the handle substrate 314 is entirely accommodated inward of the accommodating portion defining rib 3162, a state in which the accommodating portion defining rib 3162 is partially covered by the handle substrate 314 may be formed.

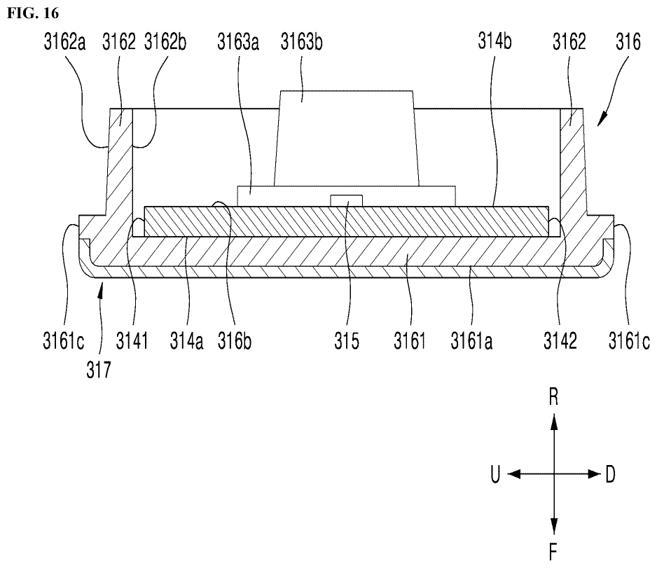

To maximize an incident area of the visible light L introduced into the accommodating portion defining rib 3162, as illustrated in FIG. 16, the handle substrate 314 may be disposed inward of the accommodating portion defining rib 3162 in a state of being spaced apart from the inner peripheral surface 3162b of the accommodating portion defining rib 3162.

In one example, as will be described later, the light guide plate 316 may be forcibly fitted into the first handle body 311.

In this regard, the accommodating portion defining rib 3162 may be forcibly fitted as an outer peripheral surface 3162a of the accommodating portion defining rib 3162 is in surface contact with the inner surface 311a of the first handle body 311.

In one example, the light guide plate 316 may further include the screw boss 3163 protruding rearwards from the rear surface 3161b of the main plate 3161.

More specifically, for example, the screw boss 3163 may include a first boss 3163a inserted into the through hole 314h of the handle substrate 314.

The first boss 3163a serves to guide a placement position of the handle substrate 314 and to prevent the handle substrate 314 from being deviated from a correct position.

To this end, the first boss 3163a may have a simple cylindrical shape in which an outer diameter thereof is uniform as the first boss 3163a extends along the front-rear direction (the F-R direction).

To pass through the through hole 314h of the handle substrate 314, the outer diameter of the first boss 3163a may be equal to or slightly smaller than an inner diameter of the through hole 314h of the handle substrate 314.

A front end of the first boss 3163a may be integrally formed with the rear surface of the main plate 3161, and a rear end of the first boss 3163a may pass through the through hole 314h and extend rearwards in a state in which the placement of the handle substrate 314 is completed.

In addition, the screw boss 3163 may further include a second boss 3163b integrally formed with the rear end of the first boss 3163a.

The second boss 3163b may have a truncated cone shape in which an outer diameter thereof is gradually reduced as the second boss 3163b extends rearwards such that the insertion coupling of the handle substrate 314 may be easily performed.

In this regard, to prevent interference with the through hole 314h of the handle substrate 314, an outer diameter of a front end of the second boss 3163b may be smaller than the outer diameter of the first boss 3163a.

In one example, a rear end of the second boss 3163b may extend beyond a rear end of the accommodating portion defining rib 3162 and toward the inner surface 311a of the first handle substrate 314 to be described later.

In one example, the first boss 3163a and the second boss 3163b may have a hollow having an inner diameter greater than an outer diameter of the screw bolt 318 such that the screw bolt 318 may pass through the screw boss 3163 and extend to the first handle substrate 314.

The hollow defined in the first boss 3163a and the second boss 3163b may be continuously defined from the front surface 3161a of the main plate 3161 to the rear end of the second boss 3163b.

### Shape of Inner Surface of First Handle Body

Hereinafter, a shape of the inner surface 311a of the first handle body 311 constituting the pop-up handle 31 of the dish washer 1 according to an embodiment of the present disclosure will be described with reference to FIGS. 17 to 21.

As described above, the inner surface 311a of the first handle body 311 may include a coupling surface 311a1 into which the light guide plate 316 is forcibly fitted, and a reflective surface 311a21 and 311a22 that reflects the visible light L generated from the lighting element 315.

In consideration of the position of the light guide plate 316 that is disposed in front of the first handle body 311 and coupled thereto, the coupling surface 311a1 may be disposed to extend rearwards from the front end of the first handle body 311.

Further, the coupling surface 311a1 may be formed as a stepped surface including a vertical surface and a horizontal surface.

In one example, the reflective surface 311a21 and 311a22 may include at least one of a flat portion extending in parallel with the handle substrate 314 disposed in front of the first handle body 311 and a curved portion forming a continuous surface with the flat portion and concavely recessed in a direction away from the handle substrate.

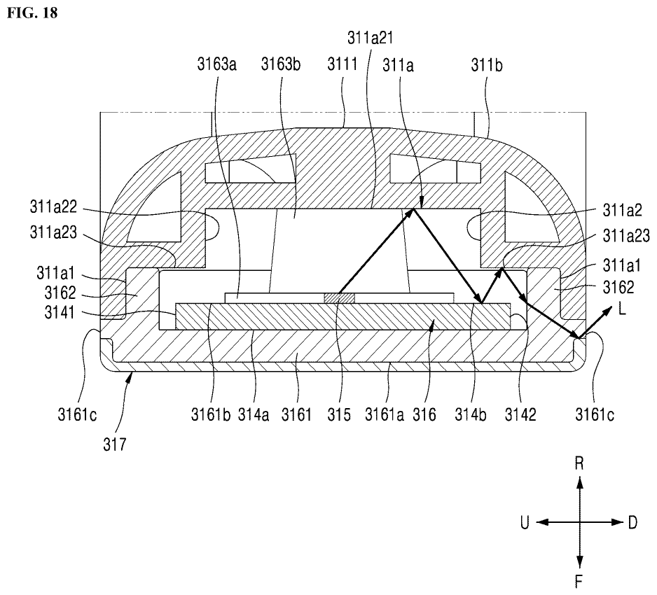

FIGS. 17 and 18 illustrate a configuration in which the reflective surface 311a21 and 311a22 of the first handle body 311 is composed of only the flat portion according to a first embodiment.

As illustrated, the reflective surface 311a21 and 311a22 of the first handle body 311 may include a first reflective surface 311a21 and a third reflective surface 311a23, which are planes parallel to the handle substrate 314, and a second reflective surface 311a22 perpendicular to the handle substrate 314.

In this regard, the second reflective surface 311a22 may be disposed between the first reflective surface 311a21 and the third reflective surface 311a23, so that the first reflective surface 311a21, the second reflective surface 311a22, and the third reflective surface 311a23 may generally form the stepped surface.

The first reflective surface 311a21, the second reflective surface 311a22, and the third reflective surface 311a23 according to the first embodiment may have a vertically symmetrical shape with respect to the single line L in which the plurality of lighting elements 315 are arranged.

Accordingly, as illustrated in FIG. 18, the visible light L generated from the plurality of lighting elements 315 may be primarily reflected by the first reflective surface 311a21 or the second reflective surface 311a22, the primarily reflected visible light L may be irradiated toward the handle substrate 314 and secondarily reflected by the handle substrate 314, and the secondarily reflected visible light L may be thirdly reflected by the third reflective surface 311a23.

The visible light L thirdly reflected by the third reflective surface 311a23 may be incident on the inner peripheral surface 3162b of the accommodating portion defining rib 3162 and then uniformly diffused and dispersed toward the upper outer edge surface 3161c and the lower outer edge surface 3161c of the main plate 3161.

In one example, in the first embodiment, the rear end of the screw boss 3163 of the light guide plate 316 is coupled to the first reflective surface 311a21 in a state of being in surface contact therewith.

Accordingly, a protruding height of the screw boss 3163 may be limited to a spacing between the first reflective surface 311a21 and the rear surface 3161b of the main plate 3161 of the light guide plate 316.

In addition, in the first embodiment, the rear end of the accommodating portion defining rib 3162 of the light guide plate 316 is coupled to the third reflective surface 311a23 in a state of being in surface contact therewith.

Accordingly, a protruding height of the accommodating portion defining rib 3162 may be limited to a spacing between the third reflective surface 311a23 and the rear surface 3161b of the main plate 3161 of the light guide plate 316.

Illustratively, the protruding height of the accommodating portion defining rib 3162 may be equal to or less than 50% of the protruding height of the screw boss 3163.

Further, the protruding height of the accommodating portion defining rib 3162 may be greater than a height at which the lighting element 315 protrudes from the rear surface 3161b of the main plate 3161 of the light guide plate 316.

The light generated from the lighting element 315 moves upwards or laterally from the lighting element 315. By setting the protruding height of the accommodating portion defining rib 3162 as described above, the present disclosure may be configured such that not only the reflected light but also the light directly from the lighting element 315 may be introduced into the accommodating portion defining rib 3162.

Further, as the protruding height and the placement position of the accommodating portion defining rib 3162 are set as described above, a diffuse reflection effect of light may be amplified through the first reflective surface 311a21, the second reflective surface 311a22, and the third reflective surface 311a23 formed as the stepped surface, and thus an amount of light introduced into the accommodating portion defining rib 3162 may be secured to be as great as possible.

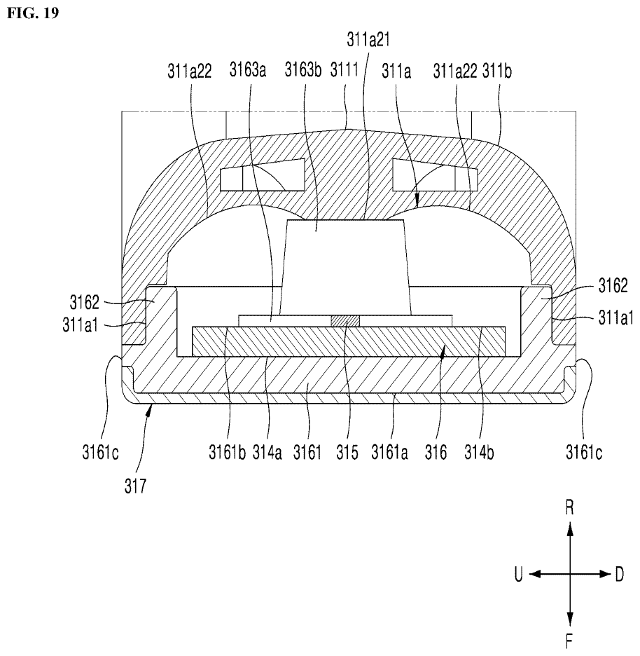

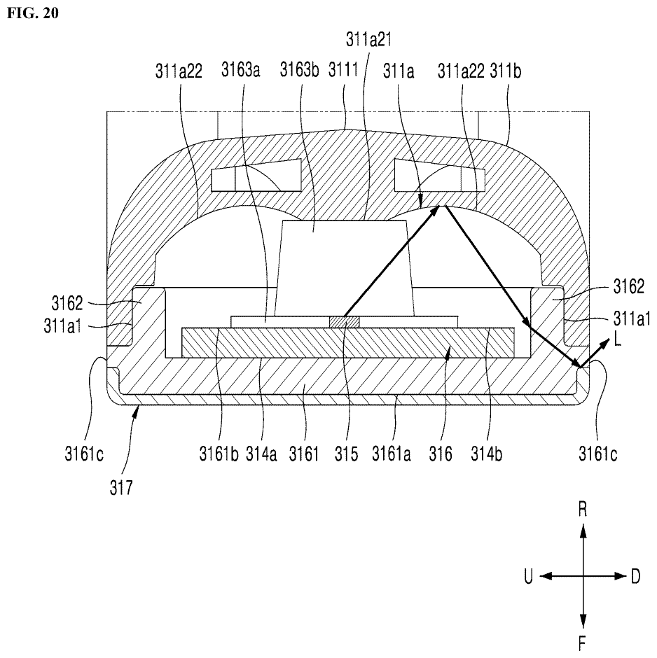

FIGS. 19 and 20 illustrate a configuration in which the reflective surface 311a21 and 311a22 of the first handle body 311 is formed as a composite surface including the flat portion and the curved portion according to a second embodiment.

As illustrated, the reflective surface 311a21 and 311a22 of the first handle body 311 according to the second embodiment may include the first reflective surface 311a21, which is a plane parallel to the handle substrate 314, and the second reflective surface 311a22, which is the curved portion concavely recessed in the direction away from the first handle substrate 314.

In this regard, a pair of second reflective surfaces 311a22 having the same shape may be disposed with the first reflective surface 311a21 interposed therebetween.

As in the first embodiment, the first reflective surface 311a21 and the second reflective surface 311a22 according to the second embodiment may have a vertically symmetrical shape with respect to the single line L in which the plurality of lighting elements 315 are arranged.

Accordingly, as shown in FIG. 20, the visible light L generated from the plurality of lighting elements 315 may be primarily reflected by the first reflective surface 311a21 or the second reflective surface 311a22, the primarily reflected visible light L may be irradiated toward the handle substrate 314 and secondarily reflected by the handle substrate 314, and the secondarily reflected visible light L may be incident on the inner peripheral surface 3162b of the accommodating portion defining rib 3162 and then uniformly diffused and dispersed toward the upper outer edge surface 3161c and the lower outer edge surface 3161c of the main plate 3161.

In one example, in the same manner as in the first embodiment, in the second embodiment, the rear end of the screw boss 3163 of the light guide plate 316 is coupled to the first reflective surface 311a21 in a state of being in surface contact therewith.

Accordingly, a protruding height of the screw boss 3163 may be limited to a spacing between the first reflective surface 311a21 and the rear surface 3161b of the main plate 3161 of the light guide plate 316.

However, unlike in the first embodiment, a vertical width of the first reflective surface 311a21 according to the second embodiment may be smaller than an outer diameter of the rear end of the screw boss 3163.

Further, a protruding height of the accommodating portion defining rib 3162 may be limited to a spacing between a front end of the second reflective surface 311a22 and the rear surface 3161b of the main plate 3161 of the light guide plate 316.

Illustratively, the protruding height of the accommodating portion defining rib 3162 may be equal to or less than 50% of the protruding height of the screw boss 3163, in the same manner as in the first embodiment.

Further, as illustrated, the rear end of the accommodating portion defining rib 3162 may be configured not to be at least partially covered by the reflective surface 311a21 and 311a22 of the first handle body 311. The light reflected by the second reflective surface 311a22 may be directly introduced through the open rear end of the accommodating portion defining rib 3162.

Therefore, the amount of light introduced into the accommodating portion defining rib 3162 may be additionally secured.

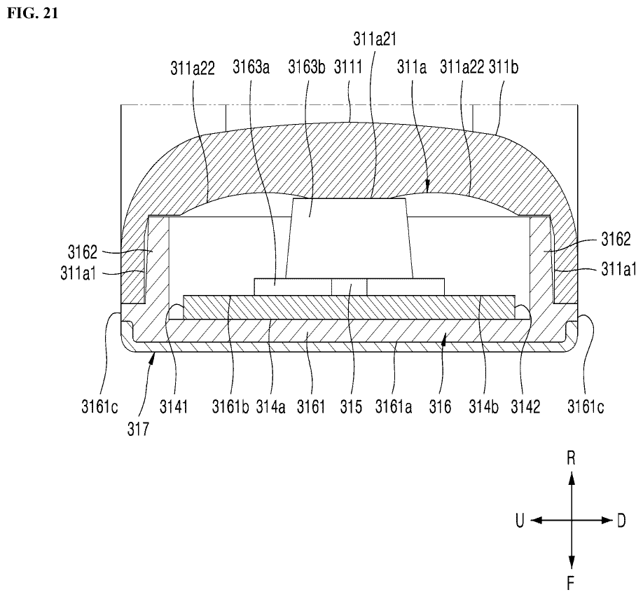

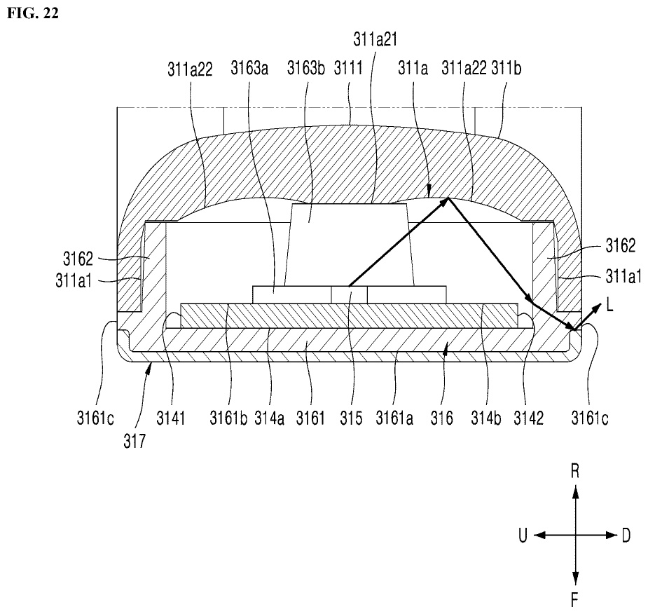

FIGS. 21 and 22 illustrate a configuration in which the reflective surface 311a21 and 311a22 of the first handle body 311 is formed as the composite surface including the flat portion and the curved portion according to a third embodiment.

As illustrated, as in the second embodiment, the reflective surface 311a21 and 311a22 of the first handle body 311 according to the third embodiment may include the first reflective surface 311a21 that is the plane parallel to the handle substrate 314, and the second reflective surface 311a22 that is the curved portion concavely recessed in the direction away from the first handle substrate 314.

In this regard, a pair of second reflective surfaces 311a22 having the same shape may be disposed with the first reflective surface 311a21 interposed therebetween.

As in the above-described embodiments, the first reflective surface 311a21 and the second reflective surface 311a22 according to the third embodiment may have a vertically symmetrical shape with respect to the single line L in which the plurality of lighting elements 315 are arranged.

Accordingly, as illustrated in FIG. 22, the visible light L generated from the plurality of lighting elements 315 may be primarily reflected by the first reflective surface 311a21 or the second reflective surface 311a22, the primarily reflected visible light L may be irradiated toward the handle substrate 314 and secondarily reflected by the handle substrate 314, and the secondarily reflected visible light L may be incident on the inner peripheral surface 3162b of the accommodating portion defining rib 3162 and then uniformly diffused and dispersed toward the upper outer edge surface 3161c and the lower outer edge surface 3161c of the main plate 3161.

In one example, in the same manner as in the above-described embodiments, in the third embodiment, the rear end of the screw boss 3163 of the light guide plate 316 is coupled to the first reflective surface 311a21 in a state of being in surface contact therewith.

Accordingly, a protruding height of the screw boss 3163 may be limited to a spacing between the first reflective surface 311a21 and the rear surface 3161b of the main plate 3161 of the light guide plate 316.

Further, in the same manner as in the second embodiment, a vertical width of the first reflective surface 311a21 according to the third embodiment may be smaller than the outer diameter of the rear end of the screw boss 3163.

However, a vertical width of the second reflective surface 311a22 according to the third embodiment may be smaller than the vertical width of the second reflective surface 311a22 according to the second embodiment.

Accordingly, a protruding height of the accommodating portion defining rib 3162 according to the third embodiment may be limited to a spacing between the front end of the second reflective surface 311a22 and the rear surface 3161b of the main plate 3161 of the light guide plate 316, but may be greater than the protruding height of the accommodating portion defining rib 3162 according to the second embodiment.

More specifically, the protruding height of the accommodating portion defining rib 3162 according to the third embodiment may be greater than 50% of the protruding height of the screw boss 3163 and less than 100% of the protruding height of the screw boss 3163.

Accordingly, the amount of light incident on the inner peripheral surface 3162b of the accommodating portion defining rib 3162 after being reflected by the first reflective surface 311a21, the second reflective surface 311a22, and the rear surface 314b of the handle substrate 314 may be increased, and finally, the amount of visible light L emitted through the outer edge surface 3161c of the main plate 3161 may be secured to a predetermined level or higher.

### Exemplary Configuration of Handle Driver and Handle Frame

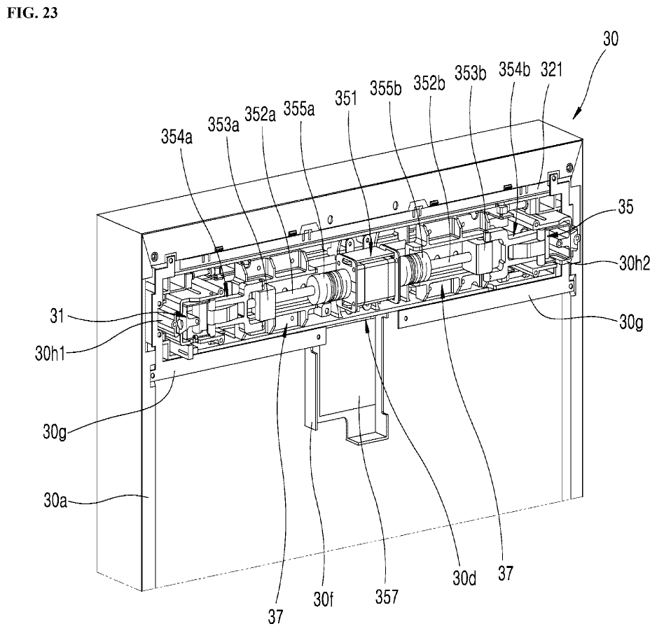

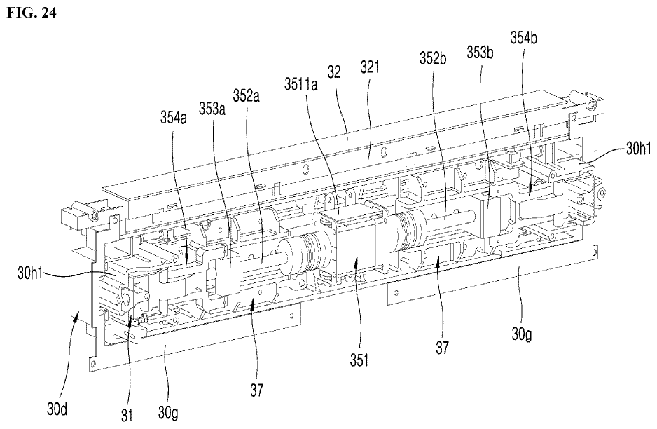

Hereinafter, referring to FIGS. 23 and 24, an exemplary configuration of the handle driver 35 that drives the pop-up handle 31 such that the pop-up handle 31 reciprocates back and forth between the extended position Pd and the retracted position Pa and the handle frame 30d that accommodates the handle driver 35 therein will be described.

The handle driver 35 may include a single driving motor 351 that receives the power and generates a rotational driving force.

Accordingly, rotational driving forces to be respectively provided to the left end of the pop-up handle 31 and the right end of the pop-up handle 31 may be collectively generated through the driving motor 351.

The rotational driving force of the driving motor 351 may be transmitted to a first lead screw 352a via a first coupler 355a.

Further, the rotational driving force of the driving motor 351 may be transmitted to a second lead screw 352a via a second coupler 355b.

A motor body of the driving motor 351 may be fixed to the inside of the handle frame 30a in a state of being accommodated in a motor bracket 3511d.

In one example, the handle driver 35 may further include a pair of lead screws 352a and 352b.

More specifically, the pair of lead screws 352a and 352b may include the first lead screw 352a that is connected to a first output shaft 3512a of the driving motor 351 and rotates by receiving the rotational driving force from the first output shaft 3512a.

In one example, a male screw thread having a predetermined longitudinal width may be formed on an outer circumferential surface of a left end of the first lead screw 352a.

A first nut 353a constituting a first motion converter 353a and 354a may be screw-coupled to the male screw thread.

As the first nut 353a linearly moves along the left-right direction (the Le-Ri direction) by a forward rotation or a reverse rotation of the first lead screw 352a, the rotational driving force of the first lead screw 352a may be converted into a linear driving force in the left-right direction (the Le-Ri direction) by the first nut 353a.

Further, the pair of lead screws may include a second lead screw 352a that is connected to a second output shaft 3512b of the driving motor 351 and rotates by receiving the rotational driving force from the second output shaft 3512b.

In one example, a male screw thread having a predetermined longitudinal width may be formed on an outer circumferential surface of a right end of the second lead screw 352b.

A second nut 353b constituting a second motion converter 353b and 354b may be screw-coupled to the male screw thread as will be described later.

In one example, the handle driver 35 may further include a pair of couplers 355a and 355b.

In one example, the handle driver 35 may further include a pair of motion converters.

The pair of motion converters may include the first motion converter 353a and 354a that converts the rotational driving force transmitted from the first lead screw 352a into a linear driving force in the front-rear direction (the F-R direction).

The linear driving force in the front-rear direction (the F-R direction) converted through the first motion converter 353a and 354a may be transmitted to the second handle body 3112 forming the left end of the pop-up handle 31.

In more detail, the first motion converter 353a and 354a may include the first nut 353a screw-coupled to the male screw of the first lead screw 352a described above.

In one example, the first motion converter 353a and 354a may further include a first link 354a that converts the linear driving force in the left-right direction (the Le-Ri direction) transmitted from the first nut 353a into the linear driving force in the front-rear direction (the F-R direction).

In one example, the pair of motion converters may include the second motion converter 353b and 354b that converts the rotational driving force transmitted from the second lead screw 352b into the linear driving force in the front-rear direction (the F-R direction).

In more detail, the second motion converter 353b and 354b may include the first nut 353b screw-coupled to the male screw of the second lead screw 352a described above.

In one example, the second motion converter 353b and 354b may further include a second link 354b that converts the linear driving force in the left-right direction (the Le-Ri direction) transmitted from the second nut 353b into the linear driving force in the front-rear direction (the F-R direction).

In one example, the handle frame 30d may be equipped with the blind module 37 that shields the opening 30e through which the pop-up handle 31 passes when the pop-up handle 31 moves from the retracted position Pa to the extended position Pd.

In addition, the dish washer 1 according to an embodiment of the present disclosure may include the handle frame 30d that accommodates the handle driver 35 and the pop-up handle 31 therein.

More specifically, the handle frame 30d may include a frame body accommodating the pop-up handle 31 and the handle driver 35 therein.

The frame body may have a hollow box shape to entirely accommodate the pop-up handle 31 and the handle driver 35 therein and support them.

In one example, a handle entrance having a cross-sectional area and a shape corresponding to the outer appearance of the pop-up handle 31 may be defined through a front wall 30d11 of the frame body such that the pop-up handle 31 may enter and exit.

To increase space utilization, a control panel holder 321 accommodating the above-described control panel 32 therein may be coupled to an upper wall 30d12 of the frame body in a state of being in surface contact therewith.

In one example, a substrate frame 30f accommodating a driver control substrate 357 therein and supporting the same may be disposed beneath the handle frame 30d.

As described above, the control panel holder 321 accommodating the control panel 32 that controls the operation of the dish washer 1 and a control panel substrate (not shown) therein may be coupled to the upper wall 30d12 of the frame body 30d1.

That is, as in the illustrated embodiment, a driver control substrate 357 for controlling the handle driver 35 may be disposed in the substrate frame 30f, separately from the control panel 32 and the control panel substrate (not shown).

However, unlike in the illustrated embodiment, the control substrates may be integrated to be a single control substrate capable of controlling both the operation of the dish washer 1 and the operation of the pop-up handle 31. Accordingly, the internal structure of the door 30 may be simplified.

Whether the control panel substrate and the driver control substrate 357 are separately equipped or integrated as described above, all of them may be electrically connected to a main controller (not shown) disposed in the main body of the dish washer 1. Accordingly, operation of various detailed components constituting the dish washer 1 including the pop-up handle 31 may be controlled by the main controller.

The handle frame 30d and the substrate frame 30f may be directly fastened to the front panel 30a of the door 30 or indirectly fastened to the front panel 30a of the door 30.

A fixing bracket 30g may be equipped as a means for indirectly fastening the handle frame 30d to the front panel 30a of the door 30.

In one example, as a means for implementing the horizontal movement of the pop-up handle 31, the handle frame 30d may include a guide bracket 30h1 and 30h2.

The guide bracket 30h1 and 30h2 serves to accommodate the second handle body 3112 and the third handle body 3113 of the pop-up handle 31 therein and guide the horizontal movements of the second handle body 3112 and the third handle body 3113 in the front-rear direction.

Illustratively, the guide bracket 30h1 and 30h2 may include a first guide bracket 30h1 accommodating the second handle body 3112 therein and a second guide bracket 30h2 accommodating the third handle body 3113 therein.

The first guide bracket 30h1 and the second guide bracket 30h2 may be integrally formed with the frame body of the handle frame 30d, or may be formed separately from the frame body and fastened to the frame body.

Although the description has been made as above with reference to the illustrated drawings for the present disclosure, the present disclosure is not limited by the embodiments disclosed herein and the drawings, and it is obvious that various modifications may be made by a person skilled in the art within the scope of the technical idea of the present disclosure. In addition, even when effects according to the configuration of the present disclosure are not explicitly described and illustrated while describing the embodiments of the present disclosure, it is natural that effects predictable by the corresponding configuration should also be recognized.

What is claimed is:

1. A dish washer comprising:
a tub defining therein a washing space having an open front surface;
a door configured to open and close the open front surface of the tub; and
a handle configured to reciprocate back and forth between an extended position where the handle protrudes frontwards from the door and a retracted position where the handle is at least partially accommodated in the door,
wherein the handle includes:
a handle body exposed outwardly of the door when the handle moves to the extended position, and
a handle illuminator configured to generate visible light from inside of the handle and irradiate visible light outwardly of the handle.

2. The dish washer of claim 1, wherein the handle illuminator includes:
a handle substrate disposed such that a thickness direction thereof is parallel to a front-rear direction; and
a plurality of lighting elements mounted on a front surface or a rear surface of the handle substrate.

3. The dish washer of claim 2, wherein the plurality of lighting elements are linearly arranged along a single line extending in a left-right direction.

4. The dish washer of claim 3, wherein the single line equally divides the handle substrate based on a vertical direction.

5. The dish washer of claim 2, wherein the plurality of lighting elements are linearly arranged along a first line extending along a left-right direction and a second line positioned below the first line and extending along the left-right direction in parallel with the first line.

6. The dish washer of claim 5, wherein a first vertical spacing between an upper edge of the handle substrate and the first line and a second vertical spacing between a lower edge of the handle substrate and the second line are equal to each other.

7. The dish washer of claim 2, wherein left-right directional spacings between respective pairs of lighting elements disposed adjacent to each other among the plurality of lighting elements are uniform.

8. The dish washer of claim 2, wherein left-right directional spacings between respective pairs of lighting elements disposed adjacent to each other among the plurality of lighting elements vary in a direction toward a left edge or a right edge of the handle substrate.

9. The dish washer of claim 8, wherein a left-right directional spacing between a pair of lighting elements disposed closest to the left edge of the handle substrate and a left-right directional spacing between a pair of lighting elements disposed closest to the right edge of the handle substrate are the smallest among the right directional spacings between the respective pairs of lighting elements.

10. The dish washer of claim 9, wherein the left-right directional spacing between the pair of lighting elements disposed closest to the left edge of the handle substrate and the left-right directional spacing between the pair of lighting elements disposed closest to the right edge of the handle substrate are equal to each other.

11. The dish washer of claim 2, wherein the handle substrate includes a plurality of through holes defined through the handle substrate in the thickness direction.

12. The dish washer of claim 11, wherein at least one of the plurality of lighting elements is disposed between a through hole defined at a leftmost side among the plurality of through holes and a left edge of the handle substrate.

13. The dish washer of claim 11, wherein at least one of the plurality of lighting elements is disposed between a through hole defined at a rightmost side among the plurality of through holes and a right edge of the handle substrate.

14. The dish washer of claim 2, wherein the handle illuminator further includes a light guide plate coupled to the handle body and configured to transmit visible light generated from the lighting elements to an outside of the handle,
wherein the handle substrate is accommodated in the light guide plate.

15. The dish washer of claim 14, wherein the light guide plate includes:
a main plate having an outer edge surface exposed to the outside; and
an accommodating portion defining rib protruding from a rear surface of the main plate toward the handle body and defining a space where the handle substrate is accommodated,
wherein an outer peripheral surface of the accommodating portion defining rib is in contact with an inner surface of the handle body.

16. The dish washer of claim 15, wherein a protruding height of the accommodating portion defining rib from the rear surface of the main plate is greater than a thickness of the main plate.

17. The dish washer of claim 15, wherein the handle substrate is disposed inward of the accommodating portion defining rib in a state of being spaced apart from an inner peripheral surface of the accommodating portion defining rib.

18. The dish washer of claim 14, wherein the plurality of lighting elements are arranged on the rear surface of the handle substrate to face an inner surface of the handle body,
wherein visible light generated from the lighting elements is reflected by the inner surface of the handle body and then is incident on the light guide plate.

19. The dish washer of claim 18, wherein the inner surface of the handle body includes one of a flat portion extending parallel to the handle substrate and a curved portion forming a continuous surface with the flat portion and concavely recessed in a direction away from the handle substrate.

20. A home appliance comprising:
a door configured to open and close an inner space having an open front surface; and
a handle configured to horizontally move between an extended position where the handle protrudes frontwards from the door and a retracted position where the handle is at least partially accommodated in the door,
wherein the handle includes a handle illuminator configured to generate visible light from inside of the handle and irradiate visible light outwardly of the handle.
